(19) United States
(12) Patent Application Publication
(10) Pub. No.: US 2018/0152333 A1
(43) Pub. Date: May 31, 2018

(54) MULTICARRIER ON-OFF KEYING WAVEFORM CODING

(71) Applicant: QUALCOMM Incorporated, San Diego, CA (US)

(72) Inventors: Stephen Jay Shellhammer, Ramona, CA (US); Bin Tian, San Diego, CA (US); Lin Yang, San Diego, CA (US)

(21) Appl. No.: 15/823,214

(22) Filed: Nov. 27, 2017

Related U.S. Application Data
(60) Provisional application No. 62/427,127, filed on Nov. 28, 2016.
(60) Provisional application No. 62/444,710, filed on Jan. 10, 2017.
(60) Provisional application No. 62/450,042, filed on Jan. 24, 2017.

(51) Int. Cl. H04L 27/34; H04L 5/00; H04L 1/00

(52) U.S. Cl. CPC H04L 27/34; H04L 5/001; H04L 27/2643; H04L 1/0033; H04L 1/0023

(57) ABSTRACT

Methods, systems, and devices for wireless communication are described that provide for generating a multicarrier wakeup signal that is modulated using multiple on-off keying (OOK) patterns. In some cases, the OOK pattern may be constructed using one or more of the following techniques: forward error correction (FEC) coding, spreading, encoding (e.g., DC balance encoding such as Manchester encoding), and orthogonal frequency division multiplexing (OFDM) overlay mapping. The resulting signal may serve to increase the sensitivity of the receiver. The OOK patterns may include on portions and off portions that are indicative of different bit values, such as a one bit or a zero bit. The multicarrier wakeup signal may be decoded by a first radio of a wireless device that compares the energy of the signal over different time periods to determine the bit value. Once determined, the wireless device may choose to activate a second radio for communication.

### CROSS REFERENCES

The present application for patent claims priority to U.S. Provisional Patent Application No. 62/427,127 by Shellhammer et al., entitled “Multicarrier On-Off Keying Waveform Coding,” filed Nov. 28, 2016, and to U.S. Provisional Patent Application No. 62/444,710 by Shellhammer et al., entitled “Multicarrier On-Off Keying Waveform Coding,” filed Jan. 10, 2017, and to U.S. Provisional Patent Application No. 62/450,042 by Shellhammer et al., entitled “Multicarrier On-Off Keying Waveform Coding,” filed Jan. 24, 2017, each of which is assigned to the assignee hereof, and expressly incorporated by reference herein.

### BACKGROUND

The present disclosure relates generally to wireless communications, and more specifically to multicarrier on-off keying (MC-OOK) waveform coding.

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a wireless local area network (WLAN), such as a Wi-Fi (i.e., Institute of Electrical and Electronics Engineers (IEEE) 802.11) network may include an access point (AP) that may communicate with one or more stations (STAs) or mobile devices. The AP may be coupled to a network, such as the Internet, and may enable a mobile device to communicate via the network (or communicate with other devices coupled to the access point). A wireless device may communicate with a network device bi-directionally. For example, in a WLAN, a STA may communicate with an associated AP via downlink (DL) or uplink (UL). The DL (or forward link) may refer to the communication link from the AP to the STA, and the UL (or reverse link) may refer to the communication link from the STA to the AP.

A wireless device (e.g., a STA) may have a limited amount of battery power. During a sleep mode, a wireless device may periodically activate a radio, such as a WLAN transceiver, to communicate with an AP. A wireless device may use a low-power receiver or wakeup receiver (WUR) to listen for and decode a wakeup message from an AP. The wakeup message may indicate whether communications are waiting at the AP to be transmitted to the wireless device. In some cases, the WUR may be unable to efficiently receive a wakeup message or may not be able to decode the wakeup message successfully. For example, the wireless device may attempt to decode one or more portions of the wakeup message signal as either a one bit or a zero bit, and may compare an energy level of the received signal to an energy threshold. In some cases, if the appropriate energy threshold is unknown, (e.g., where the transmission power of the signal is unknown to the radio) it may be difficult for the wireless device to select an energy threshold for decoding the signal, which may lead to errors in reception of the signal. Improved techniques for wakeup messaging may be desired.

### SUMMARY

The described techniques relate to improved methods, systems, devices, or apparatuses that support multicarrier on-off keying (MC-OOK) waveform coding. A transmitter of a wireless device, for example an access point (AP), may transmit a multicarrier wakeup signal to a first radio, such as a wakeup radio (WUR), of a receiver of a wireless device, such as a station (STA). The multicarrier wakeup signal may be constructed based on a generated multicarrier waveform. For example, the multicarrier wakeup signal may be modulated with OOK patterns, where each OOK pattern is representative of a different bit value. The OOK patterns may include “on” or “off” portions which may be used to mask the generated multicarrier waveform. Constructing the multicarrier wakeup signal using the OOK patterns may include applying forward error correction (FEC) coding to information bits of a wakeup message to generate multiple code bits, reducing the data rate. The code bits may then be spread, for example, by repeating each code bit a certain number of times or mapping each code bit to an orthogonal bit sequence, thereby further lowering the data rate. Each spread bit may then be converted to two or more additional bits using code that further reduces data rate and provides direct current (DC) balance, for example, by applying Manchester encoding whereby each spread bit is converted into two bits, including a one and a zero. The converted bits may then be applied to an orthogonal frequency division multiplexing (OFDM) waveform in an overlay mapping to generate the multicarrier wakeup signal. The resulting signal may serve to increase the sensitivity of the receiver.

The multicarrier waveform used to generate the multicarrier wakeup signal may include a sequence of tones that may be fixed, random, or carry encoded information bits during “on” portions of the OOK patterns used to encode the wakeup message. The fixed sequence of tones may include thirteen binary phase shift keying (BPSK) tones from tone index [−6] to tone index [6], having the following values: [1 1 1 −1 −1 −1 0 −1 1 −1 −1 1 −1], where the tone at tone index [0] is a DC subcarrier, or [1 1 1 −1 −1 −1 1 1 −1 1 1 −1 1], where the tone at tone index [0] is a BPSK [1] tone and is a DC subcarrier. Such fixed tone sequences may be associated with a minimum achievable peak-to-average power ratio (PAPR). In other examples, the sequence of tones may be randomized in a symbol period and between symbol periods to increase the diversity of the signal, which may result in a more reliable delay path profile. In yet other examples, N information bits may be sent using 2^{N} predefined sets of sequences such that a transmitter and receiver know the predefined sets of a sequences, and one or more information bit may be encoded in the tones of a symbol period using the predefined sequence. In still other examples, each tone of the symbol period may carry BPSK or quadrature phase shift keying (QPSK) modulated information bits. The information bits may include the wakeup information associated with the wakeup message or other information to be conveyed along with the MC-OOK encoded wakeup message.

Upon reception, the receiver may decode the multicarrier wakeup signal by comparing the energy levels of different time segments of the multicarrier wakeup signal. Multicarrier waveforms of different lengths or varying numbers of time segments may be used. For example, a single or multiple OOK pattern lengths may be applied to a single symbol length of a multicarrier wakeup signal, and a single OOK pattern length may be applied to a single or multiple symbol lengths of the multicarrier wakeup signal. Fractions or portions of OOK patterns lengths or the multicarrier wakeup signal may also be used.

A method of wireless communication is described. The method may include generating a multicarrier waveform based on a first plurality of subcarriers, modulating the multicarrier waveform with a plurality of OOK patterns to generate a multicarrier wakeup signal, each of the plurality of OOK patterns including one or more on portions and one or more off portions, a first OOK pattern to generate a first waveform representing a first bit value, and a second OOK pattern to generate a second waveform representing a second bit value, and transmitting the generated multicarrier wakeup signal to a wakeup radio of the wireless device.

An apparatus for wireless communication is described. The apparatus may include means for generating a multicarrier waveform based on a first plurality of subcarriers, means for modulating the multicarrier waveform with a plurality of OOK patterns to generate a multicarrier wakeup signal, each of the plurality of OOK patterns including one or more on portions and one or more off portions, a first OOK pattern to generate a first waveform representing a first bit value, and a second OOK pattern to generate a second waveform representing a second bit value, and means for transmitting the generated multicarrier wakeup signal to a wakeup radio of the wireless device.

Another apparatus for wireless communication is described. The apparatus may include a processor, memory in electronic communication with the processor, and instructions stored in the memory. The instructions may be operable to cause the processor to generate a multicarrier waveform based on a first plurality of subcarriers, modulate the multicarrier waveform with a plurality of OOK patterns to generate a multicarrier wakeup signal, each of the plurality of OOK patterns including one or more on portions and one or more off portions, a first OOK pattern to generate a first waveform representing a first bit value, and a second OOK pattern to generate a second waveform representing a second bit value, and transmit the generated multicarrier wakeup signal to a wakeup radio of the wireless device.

A non-transitory computer-readable medium for wireless communication is described. The non-transitory computer-readable medium may include instructions operable to cause a processor to generate a multicarrier waveform based on a first plurality of subcarriers, modulate the multicarrier waveform with a plurality of OOK patterns to generate a multicarrier wakeup signal, each of the plurality of OOK patterns including one or more on portions and one or more off portions, a first OOK pattern to generate a first waveform representing a first bit value, and a second OOK pattern to generate a second waveform representing a second bit value, and transmit the generated multicarrier wakeup signal to a wakeup radio of the wireless device.

In some examples of the method, apparatus, and non-transitory computer-readable medium described above, the multicarrier waveform includes a fixed sequence of tones for the first plurality of subcarriers in symbol periods of the one or more on portions.

In some examples of the method, apparatus, and non-transitory computer-readable medium described above, the fixed sequence of tones includes a first BPSK 1 tone on a first of the plurality of subcarriers. In some examples of the method, apparatus, and non-transitory computer-readable medium described above, a second BPSK 1 tone on a second of the plurality of subcarriers. In some examples of the method, apparatus, and non-transitory computer-readable medium described above, a third BPSK 1 tone on a third of the plurality of subcarriers. In some examples of the method, apparatus, and non-transitory computer-readable medium described above, a first BPSK −1 tone on a fourth of the plurality of subcarriers. In some examples of the method, apparatus, and non-transitory computer-readable medium described above, a second BPSK −1 tone on a fifth of the plurality of subcarriers. In some examples of the method, apparatus, and non-transitory computer-readable medium described above, a third BPSK −1 tone on a sixth of the plurality of subcarriers. In some examples of the method, apparatus, and non-transitory computer-readable medium described above, a DC tone on a seventh of the plurality of subcarriers. In some examples of the method, apparatus, and non-transitory computer-readable medium described above, a fourth BPSK −1 tone on an eighth of the plurality of subcarriers. In some examples of the method, apparatus, and non-transitory computer-readable medium described above, a fourth BPSK 1 tone on a ninth of the plurality of subcarriers. In some examples of the method, apparatus, and non-transitory computer-readable medium described above, a fifth BPSK −1 tone on a tenth of the plurality of subcarriers. In some examples of the method, apparatus, and non-transitory computer-readable medium described above, a sixth BPSK −1 tone on an eleventh of the plurality of subcarriers. In some examples of the method, apparatus, and non-transitory computer-readable medium described above, a fifth BPSK 1 tone on a twelfth of the plurality of subcarriers. In some examples of the method, apparatus, and non-transitory computer-readable medium described above, a seventh BPSK −1 tone on a thirteenth of the plurality of subcarriers.

In some examples of the method, apparatus, and non-transitory computer-readable medium described above, the fixed sequence of tones includes a BPSK 1 tone on a first of the plurality of subcarriers. In some examples of the method, apparatus, and non-transitory computer-readable medium described above, a second BPSK 1 tone on a second of the plurality of subcarriers. In some examples of the method, apparatus, and non-transitory computer-readable medium described above, a third BPSK 1 tone on a third of the plurality of subcarriers. In some examples of the method, apparatus, and non-transitory computer-readable medium described above, a first BPSK −1 tone on a fourth of the plurality of subcarriers. In some examples of the method, apparatus, and non-transitory computer-readable medium described above, a second BPSK −1 tone on a fifth of the plurality of subcarriers. In some examples of the method, apparatus, and non-transitory computer-readable medium described above, a third BPSK −1 tone on a sixth of the plurality of subcarriers. In some examples of the method, apparatus, and non-transitory computer-readable medium described above, a fourth BPSK 1 tone on a seventh of the plurality of subcarriers. In some examples of the method, apparatus, and non-transitory computer-readable medium described above, a fifth BPSK 1 tone on an eighth of the plurality of subcarriers. In some examples of the method, apparatus, and non-transitory computer-readable medium described above, a fourth BPSK −1 tone on a ninth of the plurality of subcarriers. In some examples of the method, apparatus, and non-transitory computer-readable medium described above, a sixth BPSK 1 tone on a tenth of the plurality of subcarriers. In some examples of the method, apparatus, and non-transitory computer-readable medium described above, a seventh BPSK 1 tone on an eleventh of the plurality of subcarriers. In some examples of the method, apparatus, and non-transitory computer-readable medium described above, a fifth BPSK −1 tone on a twelfth of the plurality of subcarriers. In some examples of the method, apparatus, and non-transitory computer-readable medium described above, an eighth BPSK 1 tone on a thirteenth of the plurality of subcarriers.

In some examples of the method, apparatus, and non-transitory computer-readable medium described above, the fixed sequence of tones for the first plurality of subcarriers includes thirteen tones located at tone indices −6:6 of a channel.

Some examples of the method, apparatus, and non-transitory computer-readable medium described above may further include processes, features, means, or instructions for generating the multicarrier waveform based on the first plurality of subcarriers by being configured to encode information bits in the plurality of subcarriers during the one or more on portions.

Some examples of the method, apparatus, and non-transitory computer-readable medium described above may further include processes, features, means, or instructions for modulating the multicarrier waveform with the plurality of OOK patterns to generate a multicarrier wakeup signal by being configured to spread a plurality of bits to generate a plurality of spread bits. Some examples of the method, apparatus, and non-transitory computer-readable medium described above may further include processes, features, means, or instructions for encoding each spread bit of the plurality of spread bits with an on-off pattern comprising at least one on portion and at least one off portion, where the total duration of the at least one on portion equals the total duration of the at least one off portion.

Some examples of the method, apparatus, and non-transitory computer-readable medium described above may further include processes, features, means, or instructions for modulating the multicarrier waveform with the plurality of OOK patterns to generate a multicarrier wakeup signal by being configured to apply a FEC code to a plurality of information bits to generate a plurality of code bits, where plurality of code bits comprise the plurality of bits to be spread.

In some examples of the method, apparatus, and non-transitory computer-readable medium described above, the FEC code includes a convolutional code, or a turbo code, or a low-density parity-check (LDPC) code, or a combination thereof.

Some examples of the method, apparatus, and non-transitory computer-readable medium described above may further include processes, features, means, or instructions for spreading the plurality of bits by being configured to repeat each bit of the plurality of bits one or more times to generate the plurality of spread bits.

Some examples of the method, apparatus, and non-transitory computer-readable medium described above may further include processes, features, means, or instructions for spreading the plurality of bits by being configured to map the plurality of bits to a plurality of orthogonal bit sequences.

In some examples of the method, apparatus, and non-transitory computer-readable medium described above, the plurality of orthogonal bit sequences include a first orthogonal bit sequence and a second orthogonal bit sequence, the first orthogonal bit sequence complementary to the second orthogonal bit sequence. Some examples of the method, apparatus, and non-transitory computer-readable medium described above may further include processes, features, means, or instructions for mapping the plurality of bits to the plurality of orthogonal bit sequences by being configured to map each of the plurality of bits to the first orthogonal bit sequence or the second orthogonal bit sequence.

In some examples of the method, apparatus, and non-transitory computer-readable medium described above, a number of the at least one on portion and a number of the at least one off portion may be equal.

In some examples of the method, apparatus, and non-transitory computer-readable medium described above, the multicarrier wakeup signal spans an integer multiple of an OFDM symbol period.

In some examples of the method, apparatus, and non-transitory computer-readable medium described above, the first OOK pattern includes a first on portion followed by a first off portion. In some examples of the method, apparatus, and non-transitory computer-readable medium described above, the second OOK pattern includes a second off portion followed by a second on portion.

Some examples of the method, apparatus, and non-transitory computer-readable medium described above may further include processes, features, means, or instructions for identifying a pending communication for a wireless device. Some examples of the method, apparatus, and non-transitory computer-readable medium described above may further include processes, features, means, or instructions for exchanging data with a second radio of the wireless device based on the transmitted multicarrier wakeup signal and the pending communication.

In some examples of the method, apparatus, and non-transitory computer-readable medium described above, the data may be exchanged with the second radio of the wireless device using a second plurality of subcarriers. In some examples of the method, apparatus, and non-transitory computer-readable medium described above, the generated multicarrier wakeup signal may be transmitted to the wakeup radio of the wireless device using first plurality of subcarriers, the first plurality of subcarriers being a subset of the second plurality of subcarriers.

A method of wireless communication is described. The method may include receiving a multicarrier wakeup signal at a first radio of a wireless device, where the multicarrier wakeup signal is modulated using a plurality of OOK patterns, each of the plurality of OOK patterns including one or more on portions and one or more off portions, a first OOK pattern used to generate a first waveform representing a first bit value, and a second OOK pattern used to generate a second waveform representing a second bit value, decoding the multicarrier wakeup signal based on the plurality of OOK patterns, and activating a second radio of the wireless device based on the decoding.

An apparatus for wireless communication is described. The apparatus may include means for receiving a multicarrier wakeup signal at a first radio of a wireless device, where the multicarrier wakeup signal is modulated using a plurality of OOK patterns, each of the plurality of OOK patterns including one or more on portions and one or more off portions, a first OOK pattern used to generate a first waveform representing a first bit value, and a second OOK pattern used to generate a second waveform representing a second bit value, means for decoding the multicarrier wakeup signal based on the plurality of OOK patterns, and means for activating a second radio of the wireless device based on the decoding.

Another apparatus for wireless communication is described. The apparatus may include a processor, memory in electronic communication with the processor, and instructions stored in the memory. The instructions may be operable to cause the processor to receive a multicarrier wakeup signal at a first radio of a wireless device, where the multicarrier wakeup signal is modulated using a plurality of OOK patterns, each of the plurality of OOK patterns including one or more on portions and one or more off portions, a first OOK pattern used to generate a first waveform representing a first bit value, and a second OOK pattern used to generate a second waveform representing a second bit value, decode the multicarrier wakeup signal based on the plurality of OOK patterns, and activate a second radio of the wireless device based on the decoding.

A non-transitory computer-readable medium for wireless communication is described. The non-transitory computer-readable medium may include instructions operable to cause a processor to receive a multicarrier wakeup signal at a first radio of a wireless device, where the multicarrier wakeup signal is modulated using a plurality of OOK patterns, each of the plurality of OOK patterns including one or more on portions and one or more off portions, a first OOK pattern used to generate a first waveform representing a first bit value, and a second OOK pattern used to generate a second waveform representing a second bit value, decode the multicarrier wakeup signal based on the plurality of OOK patterns, and activate a second radio of the wireless device based on the decoding.

Some examples of the method, apparatus, and non-transitory computer-readable medium described above may further include processes, features, means, or instructions for identifying, in the one or more on portions of the multicarrier wakeup signal, a tone sequence on a plurality of subcarriers. Some examples of the method, apparatus, and non-transitory computer-readable medium described above may further include processes, features, means, or instructions for decoding one or more information bits based on the identified sequence of tones.

Some examples of the method, apparatus, and non-transitory computer-readable medium described above may further include processes, features, means, or instructions for decoding the one or more information bits based on the identified tone sequence by being configured to determine that the identified tone sequence may be one of a set of tone sequences used to encode information bits during on portions of multicarrier wakeup signals. Some examples of the method, apparatus, and non-transitory computer-readable medium described above may further include processes, features, means, or instructions for identifying the one or more information bits associated with the one of the set of tone sequences.

Some examples of the method, apparatus, and non-transitory computer-readable medium described above may further include processes, features, means, or instructions for decoding the one or more information bits based on the identified tone sequence by being configured to demodulate each tone of the identified tone sequence to obtain the one or more information bits, each tone phase shift key modulated.

In some examples of the method, apparatus, and non-transitory computer-readable medium described above, each of the plurality of OOK patterns comprise a plurality of spread bits encoded with an on-off pattern comprising at least one on portion and at least one off portion, where the total duration of the at least one on portion equals the total duration of the at least one off portion.

In some examples of the method, apparatus, and non-transitory computer-readable medium described above, the plurality of spread bits may be generated by spreading a plurality of code bits, the plurality of code bits generated by an encoder implementing a FEC code that operates on each of a plurality of information bits.

In some examples of the method, apparatus, and non-transitory computer-readable medium described above, the plurality of spread bits may be generated by repeating each of a plurality of bits one or more times.

In some examples of the method, apparatus, and non-transitory computer-readable medium described above, the plurality of spread bits may be generated by mapping a plurality of bits to a plurality of orthogonal bit sequences.

Some examples of the method, apparatus, and non-transitory computer-readable medium described above may further include processes, features, means, or instructions for decoding the multicarrier wakeup signal by being configured to determine a first energy associated with a first time period of the multicarrier wakeup signal. Some examples of the method, apparatus, and non-transitory computer-readable medium described above may further include processes, features, means, or instructions for determining a second energy associated with a second time period of the multicarrier wakeup signal.

Some examples of the method, apparatus, and non-transitory computer-readable medium described above may further include processes, features, means, or instructions for comparing the determined first energy to the determined second energy. Some examples of the method, apparatus, and non-transitory computer-readable medium described above may further include processes, features, means, or instructions for determining whether to activate the second radio of the wireless device based on the comparing.

In some examples of the method, apparatus, and non-transitory computer-readable medium described above, the first OOK pattern includes a first on portion followed by a first off portion. In some examples of the method, apparatus, and non-transitory computer-readable medium described above, the second OOK pattern includes a second off portion followed by a second on portion.

### BRIEF DESCRIPTION OF THE DRAWINGS

FIG. 1 illustrates an example of a system for wireless communications that supports multicarrier on-off keying (MC-OOK) waveform coding in accordance with aspects of the present disclosure.

FIG. 2 illustrates an example of a wireless communications system that supports MC-OOK waveform coding in accordance with aspects of the present disclosure.

FIGS. 3A and 3B illustrate example waveforms for use in MC-OOK waveform coding in accordance with aspects of the present disclosure.

FIG. 4 illustrates an example channel subcarrier configuration that supports MC-OOK waveform coding in accordance with aspects of the present disclosure.

FIG. 5 illustrates an example binary phase shift keying (BPSK) constellation that supports MC-OOK waveform coding in accordance with aspects of the present disclosure.

FIGS. 6 and 7 illustrate examples of process flows that supports MC-OOK waveform coding in accordance with aspects of the present disclosure.

FIGS. 8 through 10 show block diagrams of a device that supports MC-OOK waveform coding in accordance with aspects of the present disclosure.

FIG. 11 illustrates a block diagram of a system including a base station that supports MC-OOK waveform coding in accordance with aspects of the present disclosure.

FIGS. 12 through 14 show block diagrams of a device that supports MC-OOK waveform coding in accordance with aspects of the present disclosure.

FIG. 15 illustrates a block diagram of a system including a user equipment (UE) that supports MC-OOK waveform coding in accordance with aspects of the present disclosure.

FIGS. 16 and 17 illustrate methods for MC-OOK keying waveform coding in accordance with aspects of the present disclosure.

### DETAILED DESCRIPTION

Aspects of the disclosure are initially described in the context of a wireless communications system, such as wireless local area network (WLAN). To conserve power, some wireless devices may include a primary radio for communicating data during an active state and a companion radio (e.g., a low-power radio such as a super regenerative receiver (SRR) or using On/Off Keying (OOK)) to receive communications during a low-power state. In order to receive communications during the low-power state, the wireless device may periodically wake up a low-power receiver (e.g., a wakeup receiver (WUR)) and listen for a wakeup message from an access point (AP) indicating that communications are waiting to be transmitted to the wireless device. As part of the power conservation, communications associated with the low-power radio may be transmitted at a lower data rate (e.g., using OOK, and specifically multicarrier OOK (MC-OOK)) than communications associated with the primary radio by using a fewer number of carriers of a multicarrier channel used by the primary radio or a combination of additional techniques. Due to a variety of factors (e.g., path loss, interference, etc.), the wireless device may be unable to decode some wakeup messages transmitted by the AP. For example, the wireless device may select an energy threshold for decoding a signal modulated using OOK (e.g., the wireless device may be using a non-coherent detector for the OOK modulated signal). However, the wireless device may be unaware of the appropriate threshold to select for a number reasons, including that the transmit power may be unknown to the receiving wireless device and/or the wireless device may not be able to successfully estimate the transmit power.

In some examples, a transmitting wireless device in a WLAN may use waveform coding. Waveform coding may involve transforming a waveform to make detection of the waveform less error prone. For example, the wireless device may generate a multicarrier waveform using a subset of carriers associated with a channel used by a primary radio, which may have a particular duration. The transmitting wireless device may then apply an OOK pattern to modulate the multicarrier waveform over a symbol period of the waveform (e.g., using some combination of forward error correction (FEC), spreading, encoding, and overlay mapping). For example, the transmitter may power 13 subcarriers of a 64-point orthogonal frequency division multiplexing (OFDM) waveform (e.g., where the 13 subcarriers of the 64-point OFDM waveform represent 4 MHz of bandwidth of a 20 MHz channel) for 4 microseconds to produce an OOK “on” signal. In some cases, the radio may indicate an OOK “off” signal by not transmitting anything. For example, the radio may not power any subcarriers of a 64-point OFDM waveform, including the 13 subcarriers.

A radio of a receiver may receive a wakeup message including the encoded multicarrier waveform and identify an OOK “on” or OOK “off” signal by comparing the received multicarrier waveform to a threshold, such as comparing the measured receive power associated with the received multicarrier waveform to a threshold receive power value. In some cases, the threshold may be predetermined, determined based on an average receive power, or a calculated value based on measured power of multicarrier waveforms over a time period. If the received power of the multicarrier waveform is greater than the threshold power, the radio may interpret the signal as a one bit, and if the received multicarrier waveform is less than the threshold, the radio may interpret the signal as a zero bit. In some cases, however, the threshold may be a non-optimal threshold which may lead to interpreting a zero bit signal as a one bit or a one bit signal as a zero bit. For example, a wakeup message or other message encoded using the OOK modulation described herein may be received, where the wakeup message encodes a large number of one bits or zero bits. The radio may then calculate a threshold that is too high or too low such that a one bit or a zero bit may be mistakenly decoded as a zero bit or a one bit, respectively.

A transmitting wireless device may mask a generated multicarrier waveform using multiple OOK patterns. The OOK patterns may include one or more “off” portions and one or more “on” portions. One OOK pattern may represent a certain bit value (e.g., a bit value of zero), while another OOK pattern may represent a different bit value (e.g., a bit value of one). Based on the OOK patterns, a transmitter may transmit the multicarrier waveform during “on” portions of an OOK pattern and not transmit the multicarrier waveform during “off” portions of the OOK pattern. That is, the transmitter may power on multiple sub-carriers during “on” portions of the OOK pattern to transmit the multicarrier waveform and may power off the multiple sub-carriers during “off” portions of the OOK pattern. Based on the OOK pattern of “on” and “off” powered sub-carriers, the transmitted signal may represent either a one bit or a zero bit, for example.

After receiving the transmitted signal at a radio of a receiver (e.g., a receiving wireless device), the receiver may decode the transmitted signal and read the multicarrier waveform as a one bit or a zero bit based on an energy comparison. In some cases, the radio of the receiver may be an example of a low-power non-coherent receiver, such as a WUR. To decode the signal, the receiver may determine the energies of the transmitted signal over one or more first time periods and compare those energies to energies of the transmitted signal over one or more second time periods. The radio may determine the difference between the energy of the first time periods and the second time periods, and if the difference is greater than zero, the radio may interpret the signal as representing a bit value of one. If the difference in energies is less than zero, the radio may interpret the signal as representing a bit value of zero. The numbers of the one or more first time periods and the one or more second time periods may be selected to be 2, 4, 6, 8, or other value known to both the transmitter and receiver. These time periods may correspond to a single OFDM symbol period for the multicarrier signal waveform or an integer number of OFDM symbol periods. In other examples, a single bit may be represented by a portion of the time periods for a single OFDM symbol period. For example, a single information bit may be represented by half of 8 time periods of the OFDM symbol or by all of the 8 time periods of a first OFDM symbol period plus another 4 time periods of a second OFDM symbol period.

Aspects of the disclosure are further illustrated by and described with reference to apparatus diagrams, system diagrams, and flowcharts that relate to MC-OOK waveform coding.

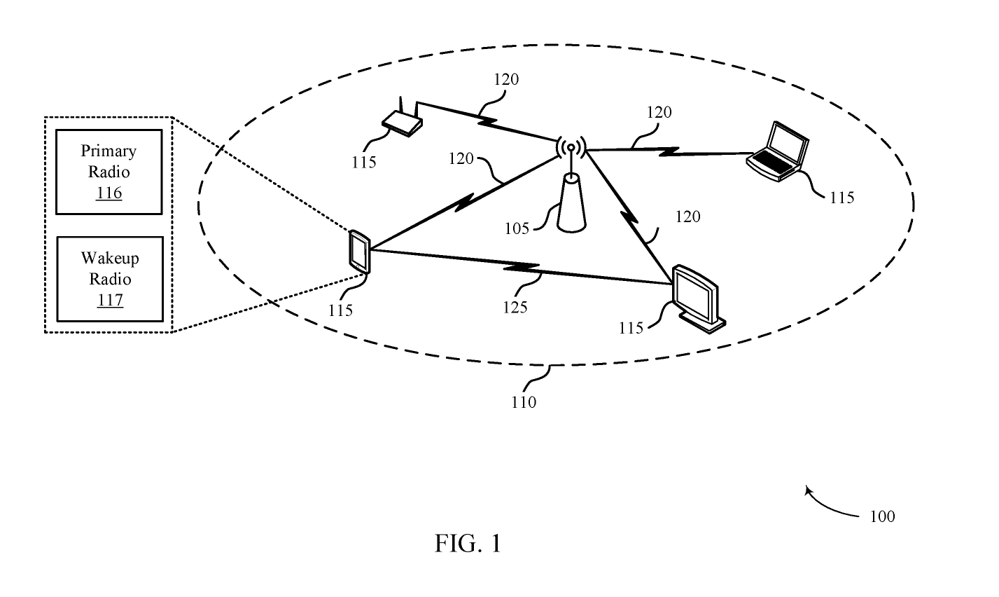

FIG. 1 illustrates a WLAN 100 (also known as a Wi-Fi network) configured in accordance with various aspects of the present disclosure. The WLAN 100 may include an AP 105 and multiple associated stations (STAs) 115, which may represent devices such as wireless communication terminals, including mobile stations, phones, personal digital assistant (PDAs), other handheld devices, netbooks, notebook computers, tablet computers, laptops, display devices (e.g., TVs, computer monitors, etc.), printers, etc. The AP 105 and the associated STAs 115 may represent a basic service set (BSS) or an extended service set (ESS). The various STAs 115 in the network are able to communicate with one another through the AP 105. Also shown is a coverage area 110 of the AP 105, which may represent a basic service area (BSA) of the WLAN 100. An extended network station associated with the WLAN 100 may be connected to a wired or wireless distribution system that may allow multiple APs 105 to be connected in an ESS.

In some examples, a STA 115 may be located in the intersection of more than one coverage area 110 and may associate with more than one AP 105. A single AP 105 and an associated set of STAs 115 may be referred to as a BSS. An ESS is a set of connected BSSs. A distribution system may be used to connect APs 105 in an ESS. In some cases, the coverage area 110 of an AP 105 may be divided into sectors. The WLAN 100 may include APs 105 of different types (e.g., metropolitan area, home network, etc.), with varying and overlapping coverage areas 110. Two STAs 115 may also communicate directly via a direct wireless link 125 regardless of whether both STAs 115 are in the same coverage area 110. Examples of direct wireless links 120 may include Wi-Fi Direct connections, Wi-Fi Tunneled Direct Link Setup (TDLS) links, and other group connections. STAs 115 and APs 105 may communicate according to the WLAN radio and baseband protocol for physical and media access control (MAC) layers from IEEE 802.11 and versions including, but not limited to, 802.11b, 802.11g, 802.11a, 802.11n, 802.11ac, 802.11ad, 802.11ah, 802.11ax, 802.11ay, 802.11az, 802.11ba, etc. In other implementations, peer-to-peer connections or ad hoc networks may be implemented within WLAN 100. Devices in WLAN 100 may additionally or alternatively communicate over shared licensed spectrum.

Devices in WLAN 100 may communicate over unlicensed spectrum, which may be a portion of spectrum that includes frequency bands traditionally used by Wi-Fi technology, such as the 5 GHz band, the 2.4 GHz band, the 60 GHz band, the 3.6 GHz band, and/or the 900 MHz band. The unlicensed spectrum may also include other frequency bands.

In some examples, a STA 115 may include multiple radios such as a low power radio (e.g., for power saving) and a higher power radio (e.g., for high throughput communication). The primary radio 116 may be used during active modes or for high-data throughput applications. The primary radio 116 may also be referred to as a primary connectivity radio or main radio. The low-power wakeup radio 117 may be used during low-power modes or for low-throughput applications. In some examples, the wakeup radio 117 may include a wakeup receiver and/or a wakeup transmitter. For example, when wireless device 115 or AP 105 may transmit a wakeup message, wireless device 115 may use a wakeup transmitter of its wakeup radio 117. When wireless device 115 may receive a wakeup message, wireless device 115 may use a wakeup receiver of its wakeup radio 117. The wakeup radio 117 may also be referred to as a companion radio, low-power companion radio, low power wakeup radio, etc.

A wakeup radio, such as wakeup radio 117, may utilize a different modulation scheme than a higher poweSPEr radio, such as primary radio 116. Modulation is the process of representing a digital signal by modifying the properties of a periodic waveform (e.g., frequency, amplitude and phase). Demodulation takes a modified waveform and generates a digital signal. A modulated waveform may be divided into time units known as symbols. Each symbol may be modulated separately. In a wireless communication system that uses narrow frequency subcarriers to transmit distinct symbols, the modulation is accomplished by varying the phase and amplitude of each symbol. For example, a binary phase shift keying (BPSK) modulation scheme conveys information by alternating between waveforms that are transmitted with no phase offset or with a 180° offset (i.e., each symbol conveys a single bit of information). In a quadrature amplitude modulation (QAM) scheme, two carrier signals (known as the in-phase component, I, and the quadrature component, Q) may be transmitted with a phase offset of 90°, and each signal may be transmitted with specific amplitude selected from a finite set. The number of amplitude bins determines the number of bits that are conveyed by each symbol.

An OOK modulation scheme may be an example of amplitude modulation in which information is conveyed by simply transmitting either at a given amplitude (for an “on” part of the signal) or at a zero amplitude (for an “off” part of the signal). In some examples of the disclosure, a multicarrier waveform may be generated and modulated using multiple OOK patterns to generate a multicarrier wakeup signal. The OOK patterns used to generate the multicarrier wakeup signal may include multiple “on” and “off” time periods during one or more OFDM symbol period to represent a single bit value (e.g., one information bit). The multicarrier wakeup signal may then be transmitted to a first radio of a wireless device, such as wakeup radio 117 of STA 115. Upon reception of the multicarrier wakeup signal, the STA 115 may decode the multicarrier wakeup signal by comparing the energy of a first portion of the wakeup signal with the energy of a second portion of the wakeup signal. Based on the comparison, the STA 115 may choose to activate a second radio, such as the primary radio 116.

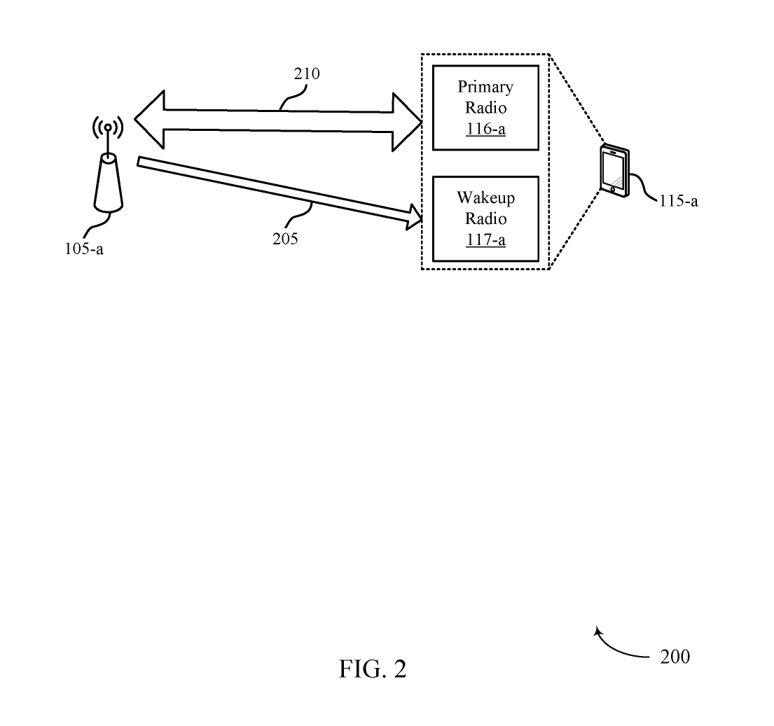

FIG. 2 illustrates an example of a wireless communications system 200 for MC-OOK waveform coding. Wireless communications system 200 may include STA 115-a and AP 105-a, which may be examples of a STA 115 and an AP 105 described herein with reference to FIG. 1. In some examples, STA 115-a may be a low power or battery powered device, such as an Internet of Things (IoT) device. STA 115-a may include a primary radio 116-a and a wakeup radio 117-a. In some aspects, STA 115-a may listen for a wakeup signal using wakeup radio 117-a, and once received, STA 115-a may activate primary radio 116-a for higher throughput communications. In some examples, wakeup radio 117-a may be a low-power radio such as a SRR or use OOK modulation to transmit or receive signals. In other aspects, STA 115-a may operate in a low power mode where wakeup radio 117-a may be used independently of primary radio 116-a for data communications. In some examples, primary radio 116-a may be a WLAN radio, including a WLAN transceiver, or a wireless wide area network (WWAN) radio, including a WWAN transceiver.

In some examples, AP 105-a may initiate communications with STA 115-a by transmitting a wakeup message using a first communication link 205. For example, AP 105-a may generate a multicarrier waveform based on waveform coding. Waveform coding may involve transforming a waveform to make detection of the waveform less error prone. For example, the multicarrier waveform may be modulated using multiple OOK patterns that represent different bit values. Each of the multiple OOK patterns may include one or more “on” portions and one or more “off” portions. The multicarrier waveform may then be masked based on the multiple OOK patterns and transmitted to wakeup radio 117-a of STA 115-a.

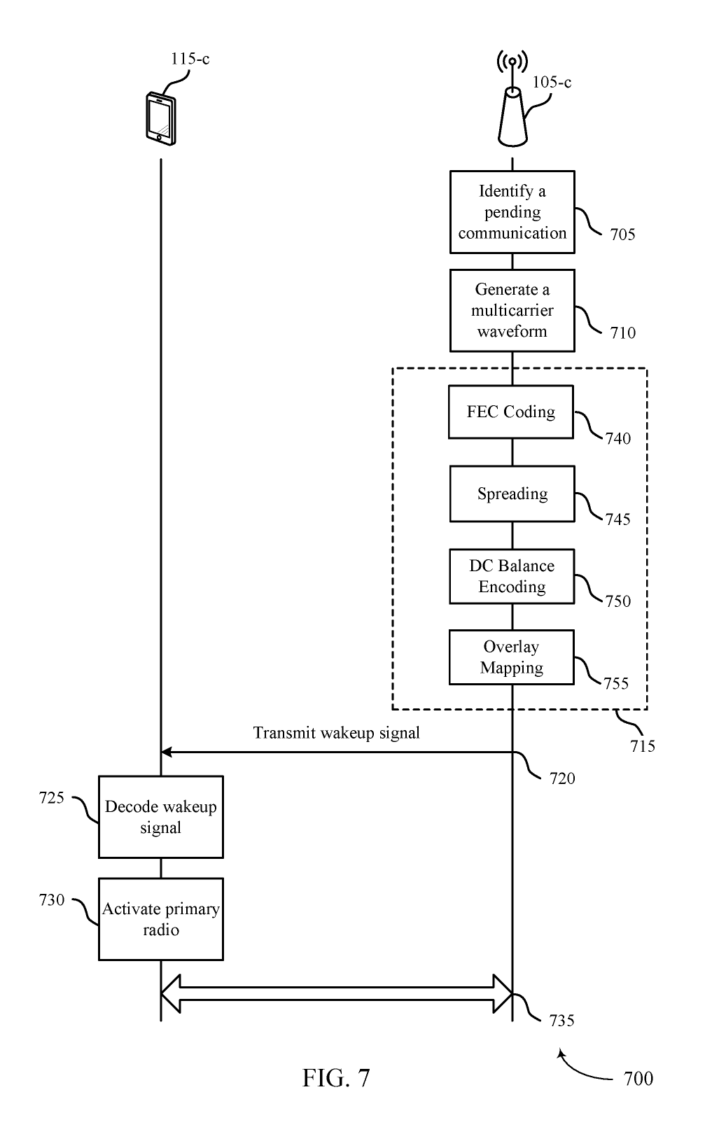

In some cases, the data rate of the OOK patterns may be lower than an OFDM symbol rate (e.g., the data rate supported by primary radio 116-a) in order to provide good receiver sensitivity using a WUR (e.g., wakeup radio 117-a), which may be a low power or ultra-low power receiver. Construction of the OOK pattern (e.g., which may alternatively be referred to as a WUR waveform) may consist of FEC coding, spreading, encoding for DC balance (e.g., using Manchester encoding), overlay mapping to a multicarrier waveform/signal, or a combination thereof. In some cases, the FEC coding, spreading, and/or DC balance encoding may each decrease the data rate of the OOK pattern such that their cumulative effect results in improved receiver sensitivity. In some cases, one of these techniques may be sufficient to produce the desired receiver sensitivity, while two or more of the techniques may be combined in other cases. Examples of these techniques are discussed further below with reference to FIG. 7.

Once STA 115-a has received and decoded the wakeup message from AP 105-a, STA 115-a may choose to activate its primary radio 116-a. If primary radio 116-a is activated, data may then be exchanged over a second communication link 210, which may be capable of a higher throughput than first communication link 205.

AP 105-a may transmit a multicarrier waveform by modulating the multicarrier waveform using multiple OOK patterns. In one example, AP 105-a may transmit an OOK “on” signal by powering multiple subcarriers. For instance, AP 105-a may power 13 subcarriers of a 64-point OFDM waveform for one or more first time periods (i.e., OOK “on” periods) and not transmit (e.g., by not powering the 13 subcarriers) for one or more second time periods (i.e., OOK “off” periods) to produce a 4 microsecond OOK signal representing a first bit value. The order and arrangement of OOK “on” and OOK “off” periods may make up an OOK pattern for the first bit value. AP 105-a may indicate a second bit value by not transmitting a signal during the one or more first time periods (i.e., OOK “off” periods) and transmitting for the one or more second time periods (i.e., OOK “on” periods), which together may make up an OOK pattern for the second bit value. In some examples, not powering the subcarriers may include masking the multicarrier waveform using the OOK patterns.

In some cases, OOK “on” periods may include transmitting energy over a subset of subcarriers of a channel (e.g., a narrowband transmission). In some cases, the content of the subcarriers (e.g., tones) during an OOK “on” periods may encode additional information, carry a fixed or random sequence of tones, etc. For example, a fixed sequence may be transmitted on the tones or subcarriers during the OOK “on” period duration. In some cases, the fixed sequence may be selected to reduce or minimize a peak-to-average power ratio (PAPR) of the wakeup signal (e.g., to facilitate higher transmission power, increased range, etc.). In other examples, additional information may be embedded into “on” subcarriers over the OOK “on” period. The additional information may be encoded as predefined sequences known to the receiver (e.g., one or more information bits may be encoded as a sequence of tones in each symbol period) and/or as modulated data in each “on” subcarrier or tone (e.g., using phase shift key modulation such as BPSK or quadrature phase shift keying (QPSK)). Such information may include, for example, wakeup signal identification information to inform non-WUR receivers of the signal type. In yet another example, each OOK “on” period may include a random data sequence, which may increase diversity (e.g., using different tone sequences from symbol period to symbol period may diversify the multicarrier waveform).

In some examples, the multicarrier waveform may be split into multiple time segments or periods, and the number of time segments as well as the length of each time segment may vary. AP 105-a may either transmit the multicarrier waveform or not transmit during each time segment or period. In some cases, the multicarrier waveform may span a particular symbol period (e.g., 4 or 8 microseconds). In other cases, each time segment may span the symbol period for the multicarrier waveform, during which the multicarrier waveform may transmit or not. In other cases, the symbol period for the multicarrier waveform and the time segments may span other set time periods.

Based on the time segments, different bit values may be represented. For example, the structure of the multiple time segments including OOK “on” and OOK “off” periods may represent a one bit value, and a different structure of the multiple time segments may represent a zero bit. In one example, AP 105-a may transmit a signal for a first time segment of the symbol period for a multicarrier waveform and may not transmit a signal for a second time segment of the multicarrier waveform symbol period. This structure may represent a one bit. In another example, AP 105-a may transmit no signal for the first time segment of the multicarrier waveform symbol period and may transmit a signal for the second time segment of the multicarrier waveform symbol period. This structure may represent a zero bit.

Wakeup radio 117-a may receive the multicarrier waveform over first communication link 205. In some examples, wakeup radio 117-a may identify an OOK “on” or OOK “off” signal by comparing the received multicarrier waveform to a threshold. For example, if the received multicarrier waveform is greater than the threshold, wakeup radio 117-a may read the signal as a one bit (e.g., OOK “on” signal), and if the received multicarrier waveform is less than the threshold, wakeup radio 117-a may read the signal as a zero bit (e.g., OOK “off” signal). In some cases, the threshold may be a non-optimal threshold. Thus, in some cases, wakeup radio 117-a may accumulate, sum, determine, or otherwise obtain the energy of a transmitted signal over in a first time segment and may obtain energy of the transmitted signal in a second time segment. Wakeup radio 117-a may then determine the difference between the accumulated energy of the first time segment and the second time segment to determine the bit value transmitted. In some examples, wakeup radio 117-a may compare the difference to a constant threshold of zero. If the difference is greater than zero, wakeup radio 117-a may read the signal as a one bit. If the difference is less than zero, wakeup radio 117-a may read the signal as a zero bit. In other examples, the difference may be compared to thresholds other than zero. Thus, the accuracy of a bit determination of an OOK modulated signal (e.g., a wakeup signal) may be increased by rendering the determination of the bit value independent of the selected threshold used to identify a one bit or a zero bit.

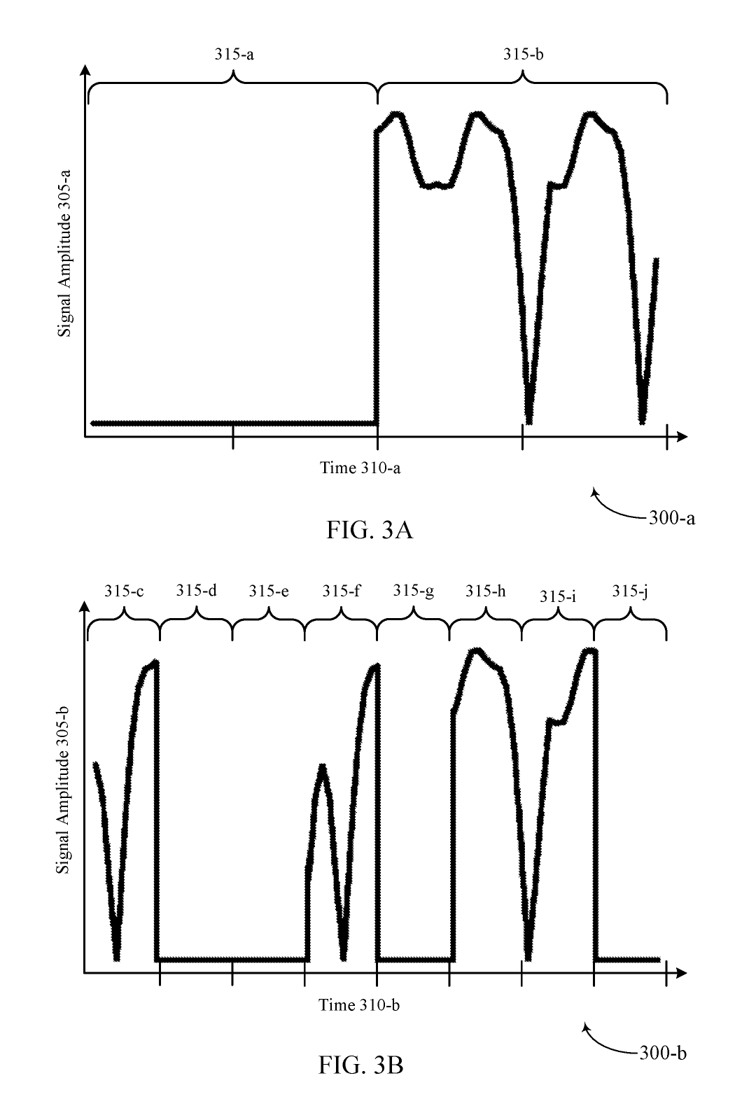

FIG. 3A illustrates an example of a waveform 300-a that supports MC-OOK waveform coding in accordance with various aspects of the present disclosure. In some cases, a transmitter, such as an AP 105 as described with reference to FIGS. 1 and 2, may transmit waveform 300-a to a receiver, such as a STA 115 as described with reference to FIGS. 1 and 2.

Waveform 300-a may be an example of a complex, multicarrier waveform. In particular, FIG. 3A depicts an amplitude 305-a of the complex, multicarrier waveform as a function of time 310-a. Each subcarrier of the multicarrier signal may be modulated using a one of various modulation schemes, such as QPSK, QAM, etc. Waveform 300-a may be an example of a multicarrier waveform modulated according to further OOK modulation representing a one bit or a zero bit. Waveform 300-a may be split into multiple time segments 315 (e.g., time periods). For example, waveform 300-a may be split into time segments 315-a and 315-b. During each time segment 315, the transmitter may either transmit a signal by powering multiple subcarriers or not transmit a signal by powering off the multiple subcarriers. The signal may be powered on or off using masking according to the OOK pattern prior to transmission. For example, the transmitter may not transmit a signal during time segment 315-a and may transmit a multicarrier waveform during time segment 315-b (e.g., an OOK “off” period followed by an OOK “on” period representing one OOK pattern). In some cases, this structure may represent a zero bit waveform. In another example, transmitter may transmit a multicarrier waveform during time segment 315-a and not transmit during time segment 315-b (e.g., an OOK “on” period followed by an OOK “off” period representing a second OOK pattern). This structure may represent one information bit. In some examples, waveform 300-a may be representative of a multicarrier wakeup signal and may span an integer multiple of OFDM symbols. In other examples, waveform 300-a may span a non-integer multiple of OFDM symbols.

Waveform 300-a may be transmitted to a receiver, such as a companion radio of a STA 115. To decode waveform 300-a, the receiver may accumulate energy in time segment 315-a and separately accumulate the energy in time segment 315-b. The receiver may then compare these energies by subtracting the accumulated energy of time segment 315-b from the accumulated energy of time segment 315-a. The resulting difference may be compared to a threshold, such as a constant threshold of zero. In this example, the difference may be less than the constant threshold of zero (i.e., the difference may be a negative value) and the receiver may interpret waveform 300-a as a zero bit waveform. In other cases, the receiver may calculate a difference greater than zero (i.e., a positive value) and may interpret the waveform 300-a as a one bit waveform.

FIG. 3B illustrates an example of a waveform 300-b that supports MC-OOK waveform coding in accordance with various aspects of the present disclosure. In some cases, a transmitter, such as an AP 105 as described with reference to FIGS. 1 and 2, may transmit waveform 300-b to a receiver, such as a STA 115 as described with reference to FIGS. 1 and 2.

Waveform 300-b may be an example of a complex, multicarrier waveform. FIG. 3B depicts an amplitude 305-b of the complex, multicarrier waveform as a function of time 310-b. Waveform 300-b may be an example of a one bit waveform or a zero bit waveform. Waveform 300-b may be split into multiple time segments 315. For example, waveform 300-b may be split into eight time segments 315-c, 315-d, 315-e, 315-f, 315-g, 315-h, 315-i, and 315-j. The time segments 315 may each span a constant time period and waveform 300-b may span a predetermined length of time. For example, in some cases, the set length of time may be a duration corresponding to a duration of one OFDM symbol corresponding to a symbol period of the multicarrier waveform underlying the waveform 300-b. In other cases, the set length of time may correspond to multiple OFDM symbols (e.g., 2 symbols in 8 microseconds, 3 symbols in 12 microseconds, 4 symbols in 16 microseconds, etc., where the OFDM symbol period is 4 microseconds). In yet other cases, the waveform 300-b may span any duration and the length of time segments 315 may vary. In some examples, a waveform spanning a longer time period may correspond to a lesser data rate but a greater signal-to-noise ratio (SNR) than a waveform spanning a shorter time period. In some examples, the waveform 300-b may be representative of a multicarrier wakeup signal and may span an integer multiple of OFDM symbols. In other examples, the waveform 300-b may span a non-integer multiple of OFDM symbols.

The waveform 300-b may be transmitted to a receiver, such as a companion radio of a STA 115. To decode waveform 300-b, the receiver may accumulate energy in time segments 315-c, 315-d, 315-e, 315-f, 315-g, 315-h, 315-i, and 315-j. For example, the receiver may receive waveform 300-b and may sum the accumulated energies of time segments 315-d, 315-e, 315-g, and 315-j (e.g., OOK “off” periods). The receiver may also sum the accumulated energies of time segments 315-c, 315-f, 315-h, and 315-I (e.g., OOK “on” periods) and may subtract this sum from the sum of the accumulated energies of time segments 315-d, 315-e, 315-g, and 315-j to calculate a difference. The resulting difference may be compared to a threshold, such as a constant threshold of zero. In this example, the difference may be less than the constant threshold of zero (i.e., the difference may be a negative value) and the receiver may interpret waveform 300-b as a zero bit waveform. In other cases, the receiver may receive calculate a difference greater than zero (i.e., a positive value) and may interpret the waveform 300-b as a one bit waveform.

According to some aspects, at least one of the OOK patterns may be a pseudo random code, which may include a pseudo random binary sequence, such as a maximum length sequence (MLS), or a pattern related to a pseudo random number, such as a pseudo random number generated by linear-feedback shift register (LFSR). In some examples, an OOK pattern may be a pseudo noise sequence, such as a maximum length pseudo noise (PN) sequence. In another example, an OOK pattern may include a maximum length pseudo random PN code with an appended zero. For example, the order of the OOK “on” periods and OOK “off” periods of eight time segments 315 (together representing the OOK pattern), may be a pseudo random code, such as a maximum length PN sequence or a maximum length PN sequence with an appended zero.

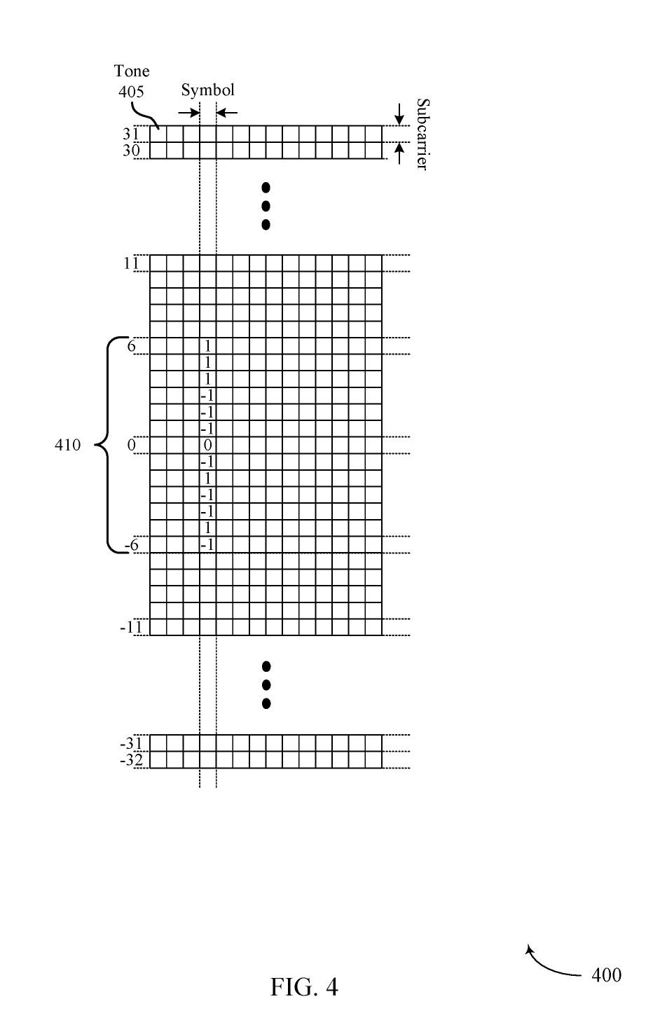

FIG. 4 illustrates an example of a channel subcarrier configuration 400 for MC-OOK waveform coding. Channel subcarrier configuration 400 may represent the operations of wireless devices, such as STAs 115 and APs 105, which may be examples of the devices described herein with reference to FIGS. 1-3. In some cases, a transmitter, such as an AP 105, may transmit a waveform according to channel subcarrier configuration 400 to a receiver, such as a STA 115 as described above.

Channel subcarrier configuration 400 may include multiple subcarriers. A tone 405 may refer to a subcarrier over the duration of a single symbol period. Sequences (e.g., tone sequences) as described herein may be transmitted across tones 405 of a single symbol period. In some cases, OOK “on” periods may consist of transmitting energy over subcarrier set 410 (e.g., a narrowband transmission). For example, channel subcarrier configuration 400 may include 64 subcarriers indexed from tone −32 to tone 31 [−32:31]. Subcarrier set 410 may be designated for sequences over a subset of the subcarriers, such as subcarriers indexed [−6:6] for MC-OOK wakeup waveform coding. That is, subcarrier set 410 may be used for transmitting sequences during OOK “on” periods. OOK “on” periods may last for the duration of an integer multiple of a symbol period (e.g., symbol duration).

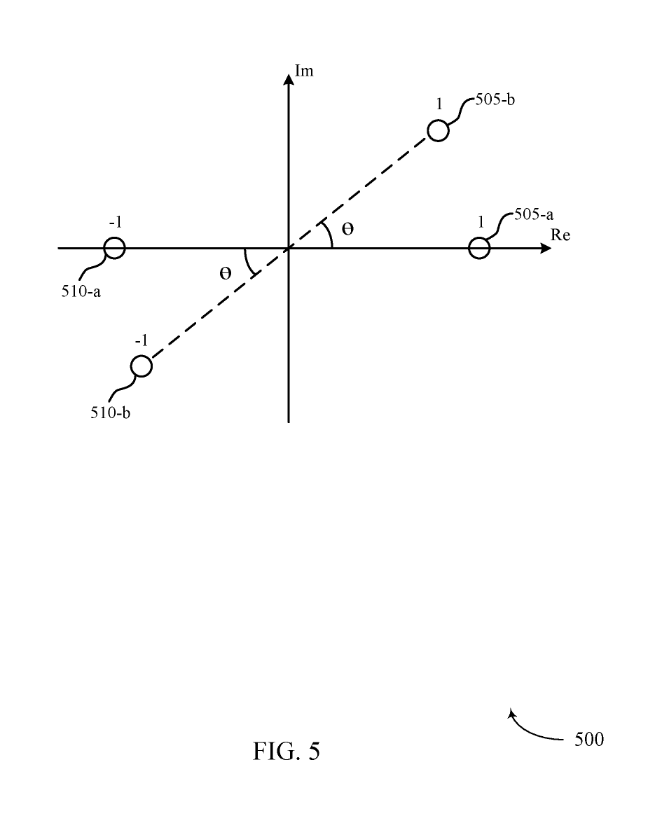

For example, a fixed sequence may be transmitted on tones 405 associated with subcarriers within subcarrier set 410 across one or more symbol periods. In some cases, the fixed sequence may be selected to reduce PAPR of the wakeup signal (e.g., to facilitate higher transmission power, increased range, etc.). For a 12 subcarrier+1 DC subcarrier (e.g., center subcarrier indexed [0], where 0 is the DC) configuration, a BPSK sequence (e.g., having a lowest PAPR) may be, from a first subcarrier to a thirteenth subcarrier within subcarrier set 410 (e.g., from tone index [−6] to tone index [6]):
[1 1 1 −1 −1 −1 0 −1 1 −1 −1 1 −1]
   as illustrated in channel subcarrier configuration 400 as an example to illustrate techniques discussed above. The preceding BPSK sequence may be a null center tone or null DC tone transmission. For a 13 subcarrier with non-zero DC configuration (e.g., center subcarrier indexed [0] is not 0), a BPSK sequence (e.g., having a lowest PAPR) may be, from a first subcarrier to a thirteenth subcarrier within subcarrier set 410 (e.g., from tone index [−6] to tone index [6]), as shown below.
[1 1 1 −1 −1 −1 1 1 −1 1 1 −1 1]
   The preceding BPSK sequence may be a non-zero center tone or non-zero DC tone transmission. Such fixed sequences may further be multiplied by a complex constant while maintaining the same or equivalent PAPR properties (e.g., as further discussed with reference to FIG. 5). The above BPSK sequence multiplied by the complex constant −j may be as illustrated below.
[−j −j −j j j j −j −j j −j −j j j]

In some cases, a fixed sequence may include a portion of a tone sequence of a symbol of a legacy preamble (e.g., from a symbol of a legacy long training field (L-LTF) tone sequence as defined in 802.11a). In such an example, subcarriers within subcarrier set 410 may be populated as illustrated below (e.g., from tone index [−6] to tone index [6], where center subcarrier [0] is the DC subcarrier).
[1 −1 1 1 1 1 0 1 −1 −1 1 1 −1]

In other examples, additional information may be encoded into subcarriers or tones 405 during “on” symbol periods (e.g., carried on subcarriers during the OOK “on” period, but not during the OOK “off” period). The additional information may be encoded as predefined sequences known to the receiver and/or as modulated data in each “on” subcarrier or tone (e.g., BPSK or QPSK modulated data). Such information may include, for example, wakeup signal identification information to inform non-WUR receivers of the signal type, a basic service set identifier (BSSID), etc. The additional information may be the same as information conveyed through OOK modulation described above with reference to FIG. 2 (e.g., information of a wakeup message) or may be different information.

In the case where information bits are encoded as predefined sequences known to the receiver, 2^{N} sets of sequences may be defined for N-bit information granularity. That is, 2^{N} sets of sequences may be defined for the subcarrier set 410 of a symbol period, with each sequence corresponding to one combination of that N-bit information set. For example, 2 information bits may be encoded in a single symbol (e.g., symbol period) using 4 different sets of tone sequences. In some examples, each of the 2^{N} sets of sequences may be orthogonal to each other of the 2^{N} sets of sequences. Depending on the N-bit information to be sent, the corresponding sequence may be transmitted using tones 405 of subcarriers within subcarrier set 410 during the OOK “on” period (e.g., one or more symbol periods).

Alternatively, tones 405 may carry information. For example, each tone 405 may encode one or more information bits (e.g., as opposed to a set of tone sequences encoding one or more information bits as described above). In one example, subcarrier set 410 may carry BPSK or QPSK modulated data, where tones 405 are a BPSK or QPSK tone. The data may be coherently demodulated at a receiver using the channel estimated from a training field (e.g., a L-LTF). For example, the encoded information may enable non-WUR receivers to understand or identify the received signal as a wakeup signal.

In yet another example, each OOK “on” period may include a random data sequence in subcarrier set 410 to increase diversity (e.g., different data sequences to diversify the waveform). For each “on” symbol period(s) of the OOK pattern, random sequences of tones may be sent (e.g., over the tones 405) within subcarrier set 410. Diversity may be increased by sending a different data sequence for each OOK “on” period.

FIG. 5 illustrates an example of a BPSK constellation 500 for MC-OOK waveform coding. BPSK constellation 500 may represent aspects of operations of wireless devices, such as STAs 115 and APs 105, which may be examples of the devices described herein with reference to FIGS. 1-4. In some cases, a transmitter, such as an AP 105, may utilize techniques described below in designing sequences of tones for wakeup waveform coding as described above with reference to FIG. 4.

Subcarrier sequences may be selected as described above with reference to FIG. 4 (e.g., to convey additional information, reduce PAPR, etc.). Further, a sequence may be multiplied by a complex constant (e.g., −1, j, etc.), and maintain the same or equivalent properties (e.g., PAPR). For example, rotated BPSK may be used in place of un-rotated BPSK. In the present example, a BPSK tone operation is illustrated which may be extended to each tone of a sequence by analogy. That is, BPSK constellation 500 illustrates a tone instance of multiplying a sequence by a complex constant. Multiplying the BPSK sequence by a complex constant may phase shift each tone (e.g., by an angle θ in a complex plane) while maintaining 180 degree (it) separation of points of the constellation. A point 505-a of “1” within a sequence may be shifted to a point 505-b, which may still be interpreted by a receiver as a “1” value. By extension, a point 510-a of “−1” within a sequence may be shifted to a point 510-b, which may still be interpreted by a receiver as a “−1.” Note that point 505-a and point 510-a may be distinguished by 180 degrees, and that e phase shifted point 505-b and e phase shifted point 510-b may also be distinguished by 180 degrees at a receiver. As such, sequences described herein may be multiplied by any complex constant and maintain properties of the unshifted sequence (e.g., PAPR benefits, information, etc.).

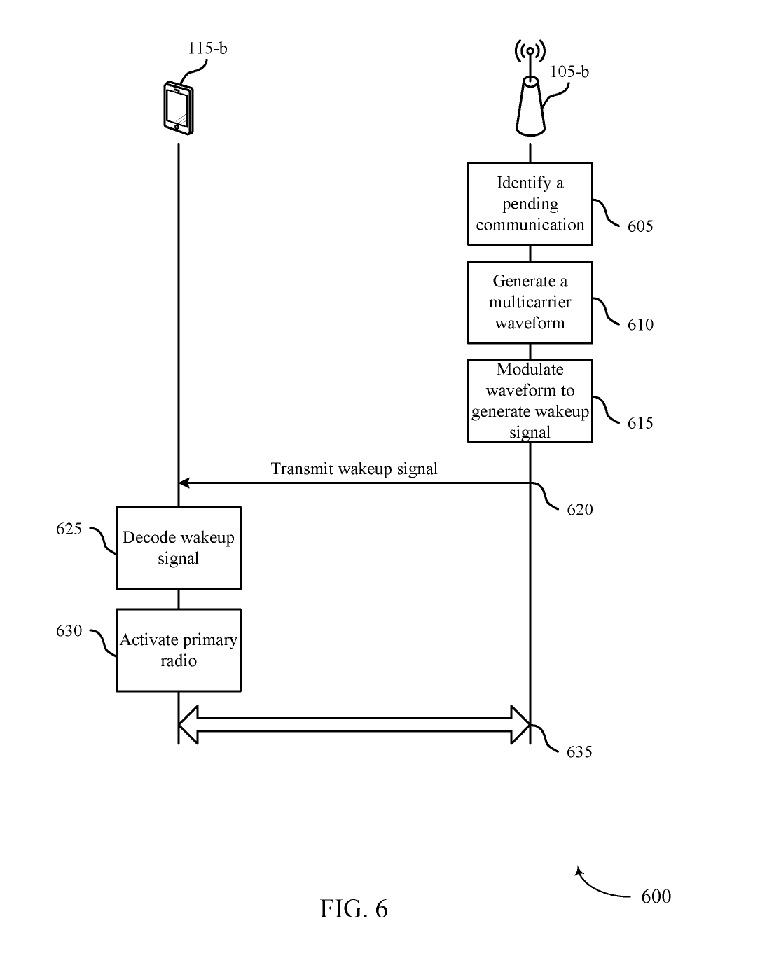

FIG. 6 illustrates an example of a process flow 600 for MC-OOK waveform coding. Process flow 600 may represent the operations of wireless devices, such as STA 115-b and AP 105-b, which may be examples of the devices described herein with reference to FIGS. 1 and 2. In some cases, the operations described as being performed by AP 105-b may be performed by another wireless device, such as a STA 115, such as in a peer mesh network or in device-to-device (D2D) communications.

At 605, AP 105-b may identify a pending communication to exchange with STA 115-b. In some instances, the pending communication may be a low power data packet to be exchanged with a low power radio, such as a companion radio or WUR, of STA 115-b. In other cases, the pending communication may be a data packet to be exchanged with STA 115-b using a higher throughput communication link.

At 610, AP 105-b may generate a multicarrier waveform. The multicarrier waveform may be generated based on a plurality of sub-carriers available for transmission by AP 105-b. In some cases, the plurality of sub-carriers may be a subset of sub-carriers capable of transmission by AP 105-b. The multicarrier waveform may be generated for transmission by the plurality of sub-carriers.

At 615, AP 105-b may modulate the multicarrier waveform to generate a wakeup signal. In some cases, the wakeup signal may be a multicarrier wakeup signal to be transmitted by multiple sub-carriers. AP 105-b may modulate the multicarrier waveform using a plurality of OOK patterns. The OOK patterns may include one or more “on” portions and one or more “off” portions. The OOK patterns may be used to mask the multicarrier waveform prior to transmission. In some cases, a first OOK pattern may include a first “on” portion followed by a first “off” portion, and a second OOK pattern may include a second “off” portion followed by a second “on” portion. In some examples, multiple “on” and “off” portions may be included in one or more OOK patterns. According to some aspects, at least one of the OOK patterns may be a pseudo random code, which may include a pseudo random binary sequence, such as a MLS, or a pattern related to a pseudo random number, such as a pseudo random number generated by LFSR. In some examples, an OOK pattern may be a pseudo noise sequence, such as a maximum length PN sequence. In another example, an OOK pattern may include a maximum length pseudo random PN code with an appended zero. Further examples are discussed below.

At 620, AP 105-b may transmit the wakeup signal including the wakeup message to STA 115-b. In some cases, the wakeup signal may be a multicarrier wakeup signal transmitted by AP 105-b using multiple sub-carriers. The wakeup signal may be transmitted to a first radio, such as a companion radio, of STA 115-b.

Upon receipt of the wakeup signal, STA 115-b may decode the wakeup signal at 625. The wakeup signal may be decoded by a companion radio of STA 115-b. In some cases, STA 115-b may decode the wakeup signal by determining an energy of the wakeup signal over a first time segment and an energy of the wakeup signal over a second time segment. The energy of the wakeup signal over a given time period may represent an aggregate of the energy transmitted on each of the underlying subcarriers carrying the wakeup message during that time period. STA 115-b may then compute a difference between the energies of the first and second time segments to determine whether the wakeup signal contain information indicative of a zero bit or a one bit.

Based on the decoding, STA 115-b may activate a primary radio at 630. The primary radio may be a WLAN radio, including a WLAN transceiver, or a WWAN radio, including a WWAN transceiver. STA 115-b may activate the primary radio by sending a signal to the primary radio in order to power on the primary radio.

At 635, STA 115-b and AP 105-b may exchange data. In some cases, the data exchanged may be the pending communication identified at 605. The data may include a low power data packet and may be exchanged between AP 105-b and STA 115-b via a companion radio of STA 115-b. In other cases, the data may include a higher throughput data packet and may be exchanged between AP 105-b and STA 115-b via the primary radio activated at 630.

FIG. 7 illustrates an example of a process flow 700 for MC-OOK waveform coding. Process flow 700 may represent the operations of wireless devices, such as STA 115-c and AP 105-c, which may be examples of the devices described herein with reference to FIGS. 1, 2, and 6. In some cases the operations described as being performed by AP 105-c may be performed by another wireless device, such as a STA 115, such as in a peer mesh network, in D2D communications, etc.

705 and 710 of FIG. 7 may correspond to 605 and 610 of FIG. 6, respectively. Accordingly, at 705, AP 105-c may identify a pending communication to exchange with STA 115-c. At 710, AP 105-c may generate a multicarrier waveform (e.g., which may be generated based on a plurality of sub-carriers available for transmission by AP 105-c).

At 715, AP 105-c may modulate the multicarrier waveform to generate a wakeup signal, using one or more of the techniques represented by 740, 745, 750, and 755. At 740, AP 105-c may apply FEC coding to the information bits (e.g., the information bits of the wakeup message) to produce code bits. Different possible FEC codes may be used. In some cases, the FEC is the rate ½ convolutional code (e.g., a same code as used in Wi-Fi). In some cases, such a configuration may enable reuse of hardware in a wireless device implementing Wi-Fi features. In this example, using ½ FEC coding, there are two code bits generated for each information bit. Other suitable coding rates (e.g., ⅓, ¼, ¾, etc.) may be also possible without deviating from the scope of the present disclosure. Other examples of FEC coding that may be used include low-density parity-check (LDPC) coding, turbo coding, other block codes, etc.

At 745, the AP 105-c may spread the code bits generated at 740. Spreading may refer to converting each code bit into a sequence of two more bits, or otherwise converting a bit into a greater number, including fractional numbers, of bits. As with FEC, there may be multiple suitable methods of achieving spreading. As an example, repetition coding may be employed in which each code bit is repeated some number N times (e.g., a 0 code bit may be represented as {0,0,0,0} and a 1 code bit may be represented as {1,1,1,1} when N=4). As a second example, the code bits may be mapped to orthogonal sequences. In this example, a 0 code bit may be represented as {0,1,0,1,1,0} while a 1 bit may be represented as {1,0,1,0,0,1}. Other orthogonal sequences are also possible, and the orthogonal sequence may be greater or shorter than 6 bits in length. These examples are provided for explanatory purposes, such that other spreading techniques are also possible. Spreading as described at 745 may contribute to providing improved receiver sensitivity at a lower data rate.

At 750, the spread code bits may be further encoded to provide DC balance. One example of such encoding that may be performed at 750 is Manchester encoding, in which a 0 bit may be represented as {0,1} and a 1 bit may be represented as {1,0}. Manchester encoding may lower the data rate by a factor of two and ensure that there is not a long string of consecutive zeroes or ones (e.g., which may contribute to an undesirable bias in the system). One of skill in the art will appreciate that similar encoding schemes may be used to similar effect without deviating from the scope of the present disclosure.

At 755, each bit of the final encoded bit sequence may be overlaid on the multicarrier waveform, which may be generated by a plurality of OFDM symbols. The resulting waveform may represent the magnitude of the encoded bit (e.g., 0 or 1) multiplied by the magnitude of the multicarrier waveform (e.g., which may be generated at 710). As an example, a zero encoded bit multiplies the multicarrier waveform by zero amplitude and obtains a zero waveform. Alternatively, a one encoded bit multiplies the multicarrier waveform and obtains the multicarrier waveform itself. In some cases, such a procedure may be referred to as OFDM overlay mapping. Examples of certain resulting waveforms are shown with reference to FIGS. 3A and 3B.

720, 725, 730, and 735 may correspond to 620, 625, 630, and 635 of FIG. 6, respectively. Accordingly, at 720, AP 105-c may transmit the wakeup signal representing the wakeup message to STA 115-c. Upon receipt of the wakeup signal, STA 115-c may decode the wakeup signal at 725. Based on the decoding (e.g., where STA 115-c determines that a wakeup message is intended for STA 115-c), STA 115-c may activate a primary radio at 730. At 735, STA 115-c and AP 105-c may exchange data or other communications. In some cases, the order of 740, 745, 750, and 755 may be modifiable (e.g., spreading at 745 may alternatively be performed after encoding for DC balance at 750, etc.).

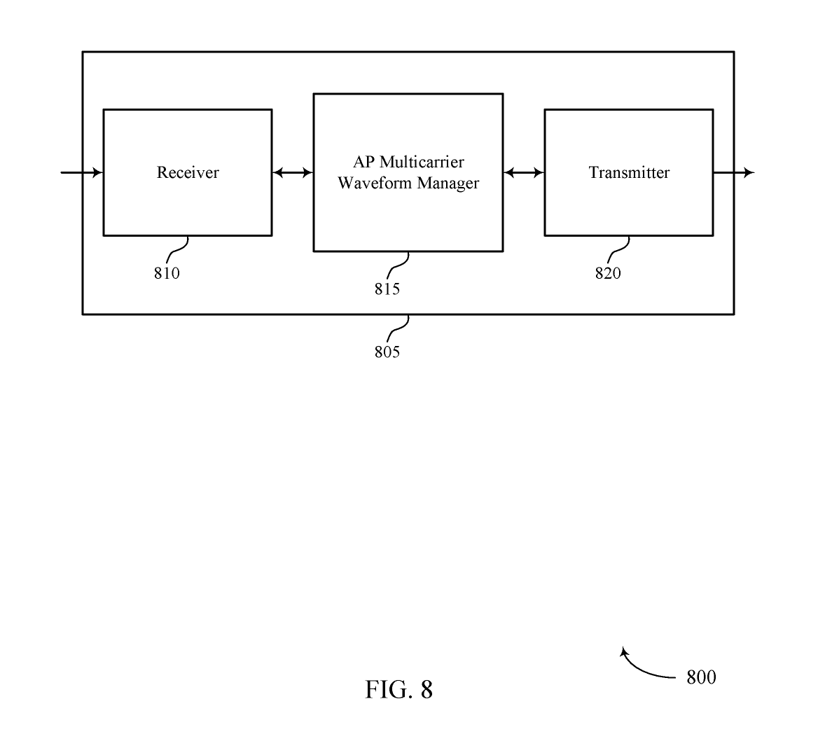

FIG. 8 shows a block diagram 800 of a wireless device 805 that supports MC-OOK waveform coding in accordance with various aspects of the present disclosure. Wireless device 805 may be an example of aspects of an AP 105 as described with reference to FIGS. 1, 2, and 4. Wireless device 805 may include receiver 810, AP multicarrier waveform manager 815, and transmitter 820. Wireless device 805 may also include one or more processors, memory coupled with the one or more processors, and instructions stored in the memory that are executable by the one or more processors to enable the one or more processors to perform the roaming features discussed herein. Each of these components may be in communication with one another (e.g., via one or more buses).

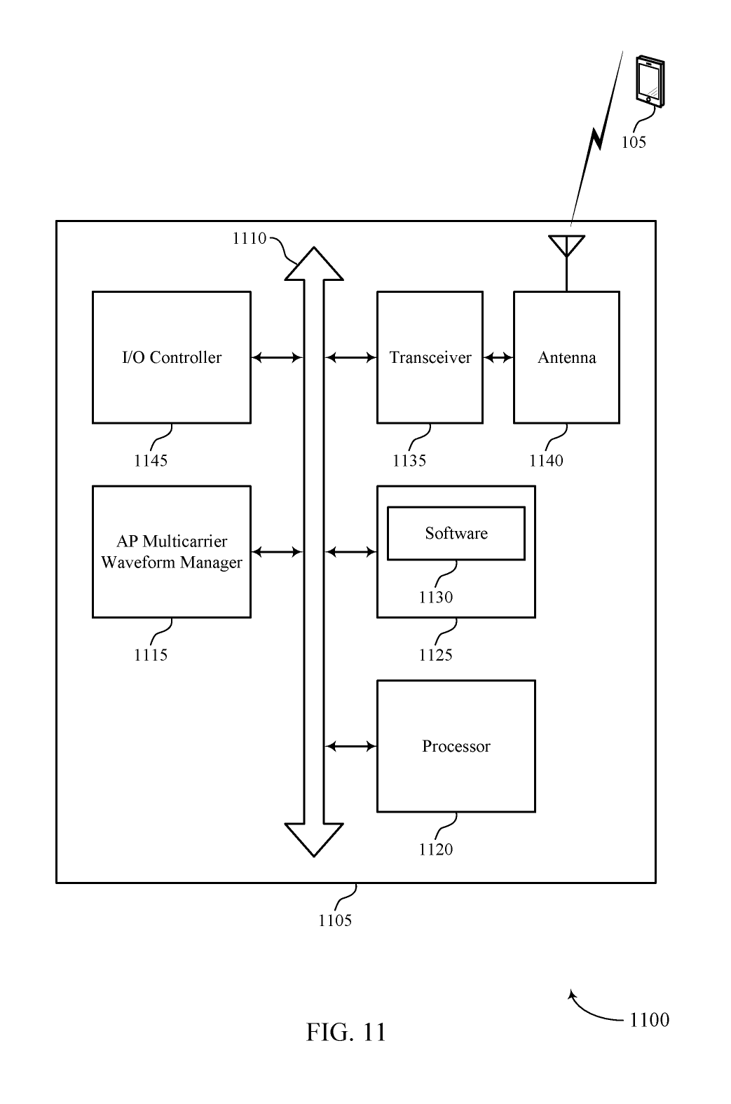

Receiver 810 may receive information such as packets, user data, or control information associated with various information channels (e.g., control channels, data channels, and information related to MC-OOK waveform coding, etc.). Information may be passed on to other components of the device. The receiver 810 may be an example of aspects of the transceiver 1135 described with reference to FIG. 11.

AP multicarrier waveform manager 815 may be an example of aspects of the AP multicarrier waveform manager 1115 described with reference to FIG. 11. AP multicarrier waveform manager 815 and/or at least some of its various sub-components may be implemented in hardware, software executed by a processor, firmware, or any combination thereof. If implemented in software executed by a processor, the functions of the AP multicarrier waveform manager 815 and/or at least some of its various sub-components may be executed by a general-purpose processor, a digital signal processor (DSP), an application-specific integrated circuit (ASIC), an field-programmable gate array (FPGA) or other programmable logic device, discrete gate or transistor logic, discrete hardware components, or any combination thereof designed to perform the functions described in the present disclosure.

AP multicarrier waveform manager 815 and/or at least some of its various sub-components may be physically located at various positions, including being distributed such that portions of functions are implemented at different physical locations by one or more physical devices. In some examples, AP multicarrier waveform manager 815 and/or at least some of its various sub-components may be a separate and distinct component in accordance with various aspects of the present disclosure. In other examples, AP multicarrier waveform manager 815 and/or at least some of its various sub-components may be combined with one or more other hardware components, including but not limited to a receiver, a transmitter, a transceiver, one or more other components described in the present disclosure, or a combination thereof in accordance with various aspects of the present disclosure.

AP multicarrier waveform manager 815 may generate a multicarrier waveform based on a first set of subcarriers, modulate the multicarrier waveform with a set of OOK patterns to generate a multicarrier wakeup signal, each of the set of OOK patterns including one or more on portions and one or more off portions, a first OOK pattern to generate a first waveform representing a first bit value, and a second OOK pattern to generate a second waveform representing a second bit value, and transmit the generated multicarrier wakeup signal to a wakeup radio of the wireless device.

Transmitter 820 may transmit signals generated by other components of the device. In some examples, the transmitter 820 may be collocated with a receiver 810 in a transceiver module. For example, the transmitter 820 may be an example of aspects of the transceiver 1135 described with reference to FIG. 11. The transmitter 820 may include a single antenna, or it may include a set of antennas.

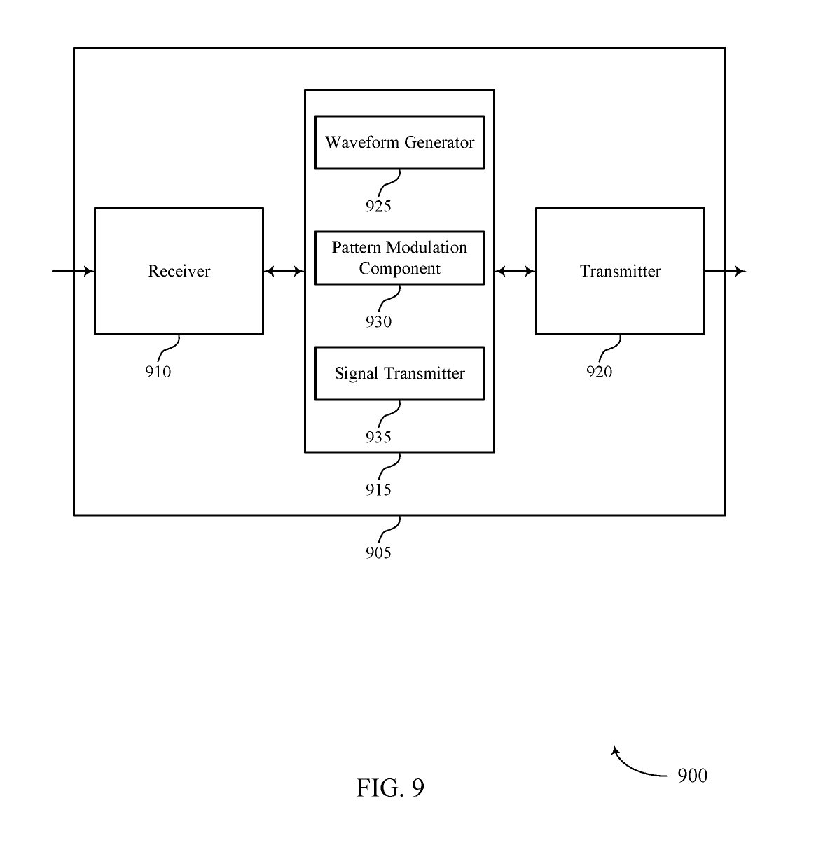

FIG. 9 shows a block diagram 900 of a wireless device 905 that supports MC-OOK waveform coding in accordance with various aspects of the present disclosure. Wireless device 905 may be an example of aspects of a wireless device 805 or an AP 105 as described with reference to FIGS. 1, 2, 6, 7, and 8. Wireless device 905 may include receiver 910, AP multicarrier waveform manager 915, and transmitter 920. Wireless device 905 may also include a processor. Each of these components may be in communication with one another (e.g., via one or more buses).

Receiver 910 may receive information such as packets, user data, or control information associated with various information channels (e.g., control channels, data channels, and information related to MC-OOK waveform coding, etc.). Information may be passed on to other components of the device. The receiver 910 may be an example of aspects of the transceiver 1135 described with reference to FIG. 11.

AP multicarrier waveform manager 915 may be an example of aspects of the AP multicarrier waveform manager 1115 described with reference to FIG. 11. AP multicarrier waveform manager 915 may also include waveform generator 925, pattern modulation component 930, and signal transmitter 935. In some examples, the AP multicarrier waveform manager 915 may be a processor (e.g., a transceiver processor, or a radio processor, or a transmitter processor). The processor may be coupled with memory and execute instructions stored in the memory that enable the processor to perform or facilitate the MC-OOK waveform coding features discussed herein. A transceiver processor may be collocated with and/or communicate with (e.g., direct the operations of) a transceiver of the device. A radio processor may be collocated with and/or communicate with (e.g., direct the operations of) a radio (e.g., a Long Term Evolution (LTE) radio or a Wi-Fi radio) of the device. A transmitter processor may be collocated with and/or communicate with (e.g., direct the operations of) a transmitter of the device.

Waveform generator 925 may generate a multicarrier waveform based on a first set of subcarriers. In some cases, the multicarrier wakeup signal spans an integer multiple of OFDM symbol periods. In some cases, the fixed sequence of tones includes a first BPSK 1 tone on a first of the set of subcarriers, a second BPSK 1 tone on a second of the set of subcarriers, a third BPSK 1 tone on a third of the set of subcarriers, a first BPSK −1 tone on a fourth of the set of subcarriers, a second BPSK −1 tone on a fifth of the set of subcarriers, a third BPSK −1 tone on a sixth of the set of subcarriers, a DC tone on a seventh of the set of subcarriers, a fourth BPSK −1 tone on an eighth of the set of subcarriers, a fourth BPSK 1 tone on a ninth of the set of subcarriers, a fifth BPSK −1 tone on a tenth of the set of subcarriers, a sixth BPSK −1 tone on an eleventh of the set of subcarriers, a fifth BPSK 1 tone on a twelfth of the set of subcarriers, and a seventh BPSK −1 tone on a thirteenth of the set of subcarriers. In other cases, the multicarrier waveform includes a fixed sequence of tones for the first set of subcarriers in symbol periods of the one or more on portions, including a first BPSK 1 tone on a first of the set of subcarriers, a second BPSK 1 tone on a second of the set of subcarriers, a third BPSK 1 tone on a third of the set of subcarriers, a first BPSK −1 tone on a fourth of the set of subcarriers, a second BPSK −1 tone on a fifth of the set of subcarriers, a third BPSK −1 tone on a sixth of the set of subcarriers, a fourth BPSK 1 tone on a seventh of the set of subcarriers, a fifth BPSK 1 tone on an eighth of the set of subcarriers, a fourth BPSK −1 tone on a ninth of the set of subcarriers, a sixth BPSK 1 tone on a tenth of the set of subcarriers, a seventh BPSK 1 tone on an eleventh of the set of subcarriers, a fifth BPSK −1 tone on a twelfth of the set of subcarriers, and an eighth BPSK 1 tone on a thirteenth of the set of subcarriers. In some cases, each BPSK 1 tone, in a complex plane, represents a complex constant times a real 1, and each BPSK −1 tone, in the complex plane, represents the complex constant times a real −1. In some cases, the fixed sequence of tones for the first set of sub carriers includes thirteen tones located at tone indices [−6:6] of a channel. In some examples, the processor and/or memory may implement some or all of the operations of the waveform generator 925. In some cases, the waveform generator 925 may be a processor (e.g., a transceiver processor, or a radio processor, or a transmitter processor). The processor may be coupled with memory and execute instructions stored in the memory that enable the processor to perform or facilitate the waveform generating features discussed herein.

Pattern modulation component 930 may modulate the multicarrier waveform with a set of OOK patterns to generate a multicarrier wakeup signal, each of the set of OOK patterns including one or more on portions and one or more off portions, a first OOK pattern to generate a first waveform representing a first bit value, and a second OOK pattern to generate a second waveform representing a second bit value. In some cases, the first OOK pattern includes a first on portion followed by a first off portion. In some cases, the second OOK pattern includes a second off portion followed by a second on portion. In some cases, the first OOK pattern includes a first set of on and off portions, including the first on portion and the first off portion, that are complementary to a second set of on and off portions, including the second on portion and the second off portion, of the second OOK pattern. In some cases, the first OOK pattern, or the second OOK pattern, or a combination thereof include a pseudo random code. In some cases, the pseudo random code includes a maximum length PN sequence or a maximum length PN sequence with an appended zero. In some cases, the pattern modulation component 930 may be a processor (e.g., a transceiver processor, or a radio processor, or a transmitter processor). The processor may be coupled with memory and execute instructions stored in the memory that enable the processor to perform or facilitate the modulation features discussed herein.

Signal transmitter 935 may transmit the generated multicarrier wakeup signal to a wakeup radio of the wireless device and transmit the generated multicarrier wakeup signal using the first set of subcarriers. In some cases, the generated multicarrier wakeup signal is transmitted to the wakeup radio of the wireless device using first set of subcarriers, the first set of subcarriers being a subset of the second set of subcarriers. In some examples, the processor and/or memory may implement some or all of the operations of the multicarrier waveform manager 915. In some cases, the signal transmitter 935 may be a processor (e.g., a transceiver processor, or a radio processor, or a transmitter processor). The processor may be coupled with memory and execute instructions stored in the memory that enable the processor to perform or facilitate the signal transmitting features discussed herein.

Transmitter 920 may transmit signals generated by other components of the device. In some examples, the transmitter 920 may be collocated with a receiver 910 in a transceiver module. For example, the transmitter 920 may be an example of aspects of the transceiver 1135 described with reference to FIG. 11. The transmitter 920 may include a single antenna, or it may include a set of antennas.

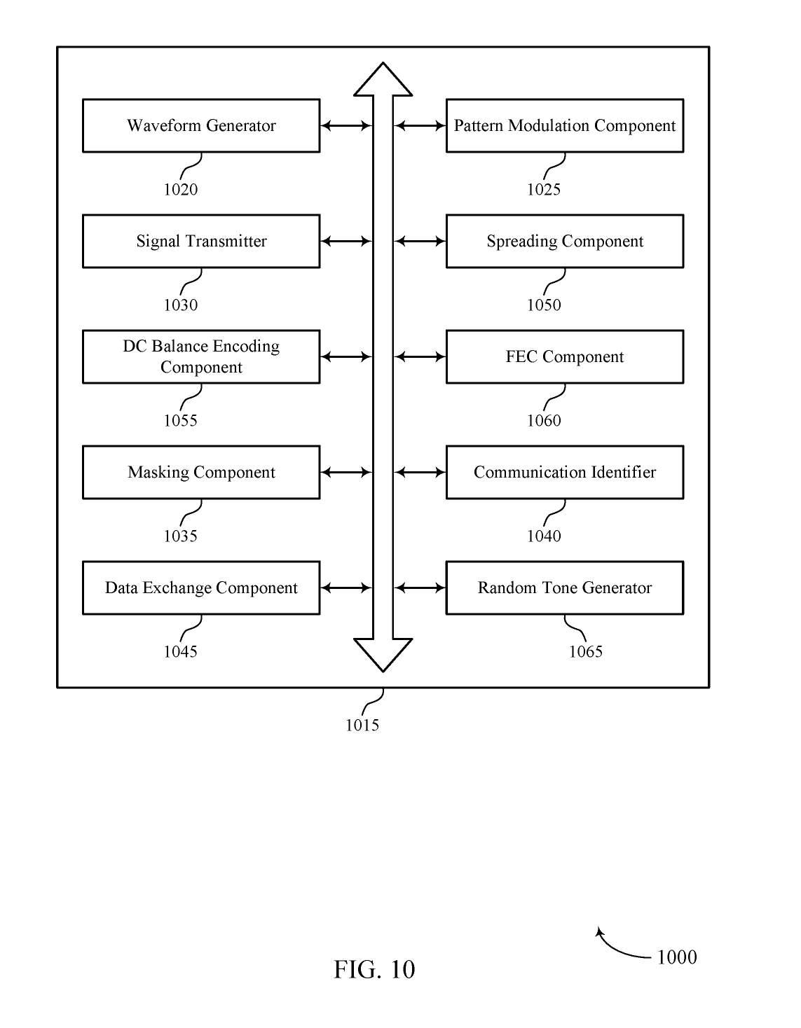

FIG. 10 shows a block diagram 1000 of an AP multicarrier waveform manager 1015 that supports MC-OOK waveform coding in accordance with various aspects of the present disclosure. The AP multicarrier waveform manager 1015 may be an example of aspects of an AP multicarrier waveform manager 815, an AP multicarrier waveform manager 915, or an AP multicarrier waveform manager 1115 described with reference to FIGS. 8, 9, and 11. The AP multicarrier waveform manager 1015 may include waveform generator 1020, pattern modulation component 1025, signal transmitter 1030, masking component 1035, communication identifier 1040, data exchange component 1045, spreading component 1050, DC balance encoding component 1055, and FEC component 1060. Each of these modules may communicate, directly or indirectly, with one another (e.g., via one or more buses).

Waveform generator 1020 may generate a multicarrier waveform based on a first set of subcarriers. In some examples, the processor and/or memory may implement some or all of the operations of the waveform generator 1020. In some cases, the waveform generator 1020 may be a processor (e.g., a transceiver processor, or a radio processor, or a transmitter processor). The processor may be coupled with memory and execute instructions stored in the memory that enable the processor to perform or facilitate the waveform generating features discussed herein. Waveform generator 1020 may be an example of, and implement the features described with reference to, waveform generator 925.

Pattern modulation component 1025 may modulate the multicarrier waveform with a set of OOK patterns to generate a multicarrier wakeup signal, each of the set of OOK patterns including one or more on portions and one or more off portions, a first OOK pattern to generate a first waveform representing a first bit value, and a second OOK pattern to generate a second waveform representing a second bit value. In some cases, the first OOK pattern includes a first on portion followed by a first off portion. In some cases, the second OOK pattern includes a second off portion followed by a second on portion. In some cases, the first OOK pattern includes a first set of on and off portions, including the first on portion and the first off portion, that are complementary to a second set of on and off portions, including the second on portion and the second off portion, of the second OOK pattern. In some cases, the first OOK pattern, or the second OOK pattern, or a combination thereof include a pseudo random code. In some cases, the pseudo random code includes a maximum length PN sequence or a maximum length PN sequence with an appended zero. In some cases, the pattern modulation component 1025 may be a processor (e.g., a transceiver processor, or a radio processor, or a transmitter processor). The processor may be coupled with memory and execute instructions stored in the memory that enable the processor to perform or facilitate the modulation features discussed herein.

Signal transmitter 1030 may transmit the generated multicarrier wakeup signal to a wakeup radio of the wireless device and transmit the generated multicarrier wakeup signal using the first set of subcarriers. In some cases, the generated multicarrier wakeup signal is transmitted to the wakeup radio of the wireless device using first set of subcarriers, the first set of subcarriers being a subset of the second set of subcarriers. In some cases, the signal transmitter 1030 may be a processor (e.g., a transceiver processor, or a radio processor, or a transmitter processor). The processor may be coupled with memory and execute instructions stored in the memory that enable the processor to perform or facilitate the signal transmitting features discussed herein.

Masking component 1035 may mask a multicarrier waveform. In some cases, modulating the multicarrier waveform with the set of OOK patterns includes masking the generated multicarrier waveform with the set of OOK patterns. In some cases, the masking component 1035 may be a processor (e.g., a transceiver processor, or a radio processor, or a transmitter processor). The processor may be coupled with memory and execute instructions stored in the memory that enable the processor to perform or facilitate the masking features discussed herein.

Communication identifier 1040 may identify a pending communication for a wireless device. In some cases, the communication identifier 1040 may be a processor (e.g., a transceiver processor, or a radio processor, or a transmitter processor). The processor may be coupled with memory and execute instructions stored in the memory that enable the processor to perform or facilitate the communication identification features discussed herein.

Data exchange component 1045 may exchange data with a second radio of the wireless device based on the transmitted multicarrier wakeup signal and the pending communication. In some cases, the data is exchanged with the second radio of the wireless device using a second set of subcarriers. In some cases, the data exchange component 1045 may be a processor (e.g., a transceiver processor, or a radio processor, or a transmitter processor). The processor may be coupled with memory and execute instructions stored in the memory that enable the processor to perform or facilitate the data exchange features discussed herein.

Spreading component 1050 may map the set of bits to the set of orthogonal bit sequences and may map each of the set of bits to the first orthogonal bit sequence or the second orthogonal bit sequence. In some cases, modulating the multicarrier waveform with the set of OOK patterns to generate a multicarrier wakeup signal includes spreading a set of bits to generate a set of spread bits, which may be performed by spreading component 1050. In some cases, spreading the set of bits includes repeating each bit of the set of bits one or more times to generate the set of spread bits. In some cases, spreading the set of bits includes mapping the set of bits to a set of orthogonal bit sequences. In some cases, the set of orthogonal bit sequences includes a first orthogonal bit sequence and a second orthogonal bit sequence, the first orthogonal bit sequence complementary to the second orthogonal bit sequence.

DC balance encoding component 1055 may encode each spread bit of the set of spread bits with an on-off pattern including at least one on portion and at least one off portion, where the total duration of the at least one on portion equals the total duration of the at least one off portion. In some cases, a number of the at least one on portion and a number of the at least one off portion are equal. In some cases, modulating the multicarrier waveform with the set of OOK patterns to generate a multicarrier wakeup signal further includes applying the encoded set of spread bits to the multicarrier waveform to generate the multicarrier wakeup signal. In some cases, generating the multicarrier waveform based on the first set of subcarriers includes encoding information bits in the set of subcarriers during the one or more on portions. In some cases, encoding the information bits in the set of subcarriers includes selecting one of a set of tone sequences to encode one or more of the information bits in each of the one or more on portions. In some cases, the information bits include a set of N information bits in each symbol period of the one or more on portions. In some cases, the set of tone sequences include 2^{N} tone sequences. In some cases, each of the 2^{N} tone sequences correspond to one of the set of N information bits. In some cases, encoding information bits in each symbol period of the one or more on portions includes modulating the first set of subcarriers using phase shift keying during the one or more on portions to carry the information bits. In some cases, a number of the at least one on portion and a number of the at least one off portion are equal. In some cases, modulating the multicarrier waveform with the set of OOK patterns to generate a multicarrier wakeup signal further includes applying the encoded set of spread bits to the multicarrier waveform to generate the multicarrier wakeup signal.

FEC component 1060 may apply a FEC code to information. In some cases, modulating the multicarrier waveform with the set of OOK patterns to generate a multicarrier wakeup signal further includes applying a FEC code to a set of information bits to generate a set of code bits, where set of code bits include the set of bits to be spread. In some cases, modulating the multicarrier waveform with the set of OOK patterns includes applying a FEC code to a set of information bits to generate a set of code bits. In some cases, the FEC code includes a convolutional code, a turbo code, or a LDPC code.

Random tone generator 1065 may generate the multicarrier waveform based on the first set of subcarriers and the selected one or more random tone sequences, and switch the one or more random tone sequences between each of the one or more on portions. In some cases, generating the multicarrier waveform based on a first set of subcarriers includes selecting one or more random tone sequences for symbol periods of the one or more on portions, each of the one or more random tone sequences including tones for the first set of subcarriers during one or more of the symbol periods.

FIG. 11 shows a diagram of a system 1100 including a device 1105 that supports MC-OOK waveform coding in accordance with various aspects of the present disclosure. Device 1105 may be an example of or include the components of wireless device 805, wireless device 905, or an AP 105 as described above, e.g., with reference to FIGS. 1, 8 and 9. Device 1105 may include components for bi-directional voice and data communications including components for transmitting and receiving communications, including AP multicarrier waveform manager 1115, processor 1120, memory 1125, software 1130, transceiver 1135, antenna 1140, and I/O controller 1145. These components may be in electronic communication via one or more busses (e.g., bus 1110).

Processor 1120 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, processor 1120 may be configured to operate a memory array using a memory controller. In other cases, a memory controller may be integrated into processor 1120. Processor 1120 may be configured to execute computer-readable instructions stored in a memory to perform various functions (e.g., functions or tasks supporting MC-OOK waveform coding).

Memory 1125 may include random access memory (RAM) and read only memory (ROM). The memory 1125 may store computer-readable, computer-executable software 1130 including instructions that, when executed, cause the processor to perform various functions described herein. In some cases, the memory 1125 may contain, among other things, a basic input/output system (BIOS) which may control basic hardware and/or software operation such as the interaction with peripheral components or devices.

Software 1130 may include code to implement aspects of the present disclosure, including code to support MC-OOK waveform coding. Software 1130 may be stored in a non-transitory computer-readable medium such as system memory or other memory. In some cases, the software 1130 may not be directly executable by the processor but may cause a computer (e.g., when compiled and executed) to perform functions described herein.

Transceiver 1135 may communicate bi-directionally, via one or more antennas, wired, or wireless links as described above. For example, the transceiver 1135 may represent a wireless transceiver and may communicate bi-directionally with another wireless transceiver. The transceiver 1135 may also include a modem to modulate the packets and provide the modulated packets to the antennas for transmission, and to demodulate packets received from the antennas.

In some cases, the wireless device may include a single antenna 1140. However, in some cases the device may have more than one antenna 1140, which may be capable of concurrently transmitting or receiving multiple wireless transmissions.

I/O controller 1145 may manage input and output signals for device 1105. I/O controller 1145 may also manage peripherals not integrated into device 1105. In some cases, I/O controller 1145 may represent a physical connection or port to an external peripheral. In some cases, I/O controller 1145 may utilize an operating system such as iOS®, ANDROID®, MS-DOS®, MS-WINDOWS®, OS/2®, UNIX®, LINUX®, or another known operating system.

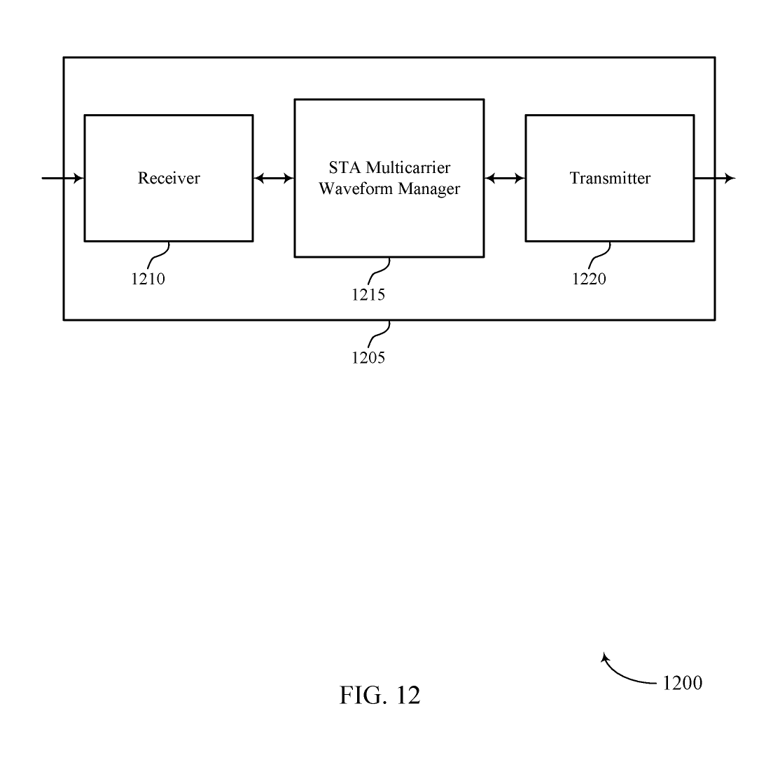

FIG. 12 shows a block diagram 1200 of a wireless device 1205 that supports MC-OOK waveform coding in accordance with various aspects of the present disclosure. Wireless device 1205 may be an example of aspects of a STA 115 as described with reference to FIGS. 1, 2, and 4. Wireless device 1205 may include receiver 1210, STA multicarrier waveform manager 1215, and transmitter 1220. Wireless device 1205 may also include one or more processors, memory coupled with the one or more processors, and instructions stored in the memory that are executable by the one or more processors to enable the one or more processors to perform the roaming features discussed herein. Each of these components may be in communication with each other. Each of these components may be in communication with one another (e.g., via one or more buses).

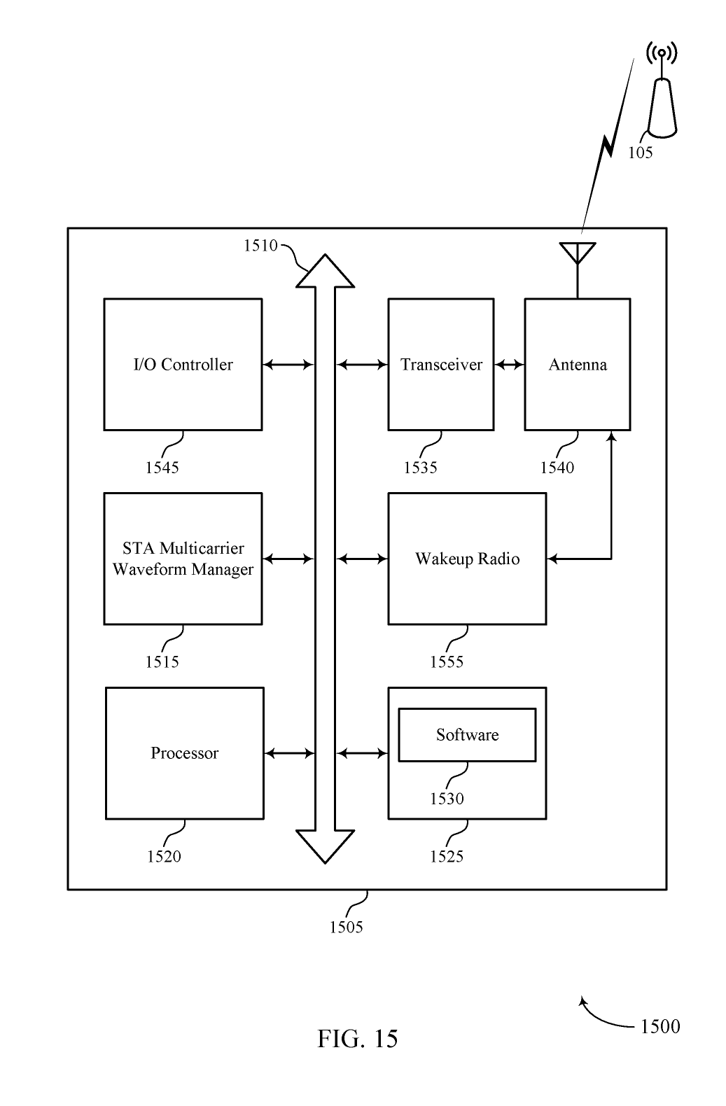

Receiver 1210 may receive information such as packets, user data, or control information associated with various information channels (e.g., control channels, data channels, and information related to MC-OOK waveform coding, etc.). Information may be passed on to other components of the device. The receiver 1210 may be an example of aspects of the transceiver 1535 described with reference to FIG. 15.

STA multicarrier waveform manager 1215 may be an example of aspects of the STA multicarrier waveform manager 1515 described with reference to FIG. 15. STA multicarrier waveform manager 1215 and/or at least some of its various sub-components may be implemented in hardware, software executed by a processor, firmware, or any combination thereof. If implemented in software executed by a processor, the functions of the STA multicarrier waveform manager 1215 and/or at least some of its various sub-components may be executed by a general-purpose processor, a DSP, an ASIC, an FPGA or other programmable logic device, discrete gate or transistor logic, discrete hardware components, or any combination thereof designed to perform the functions described in the present disclosure.

The STA multicarrier waveform manager 1215 and/or at least some of its various sub-components may be physically located at various positions, including being distributed such that portions of functions are implemented at different physical locations by one or more physical devices. In some examples, STA multicarrier waveform manager 1215 and/or at least some of its various sub-components may be a separate and distinct component in accordance with various aspects of the present disclosure. In other examples, STA multicarrier waveform manager 1215 and/or at least some of its various sub-components may be combined with one or more other hardware components, including but not limited to a receiver, a transmitter, a transceiver, one or more other components described in the present disclosure, or a combination thereof in accordance with various aspects of the present disclosure.

STA multicarrier waveform manager 1215 may receive a multicarrier wakeup signal at a first radio of a wireless device, where the multicarrier wakeup signal is modulated using a set of OOK patterns, each of the set of OOK patterns including one or more on portions and one or more off portions, a first OOK pattern used to generate a first waveform representing a first bit value, and a second OOK pattern used to generate a second waveform representing a second bit value, decode the multicarrier wakeup signal based on the set of OOK patterns, and activate a second radio of the wireless device based on the decoding.

Transmitter 1220 may transmit signals generated by other components of the device. In some examples, the transmitter 1220 may be collocated with a receiver 1210 in a transceiver module. For example, the transmitter 1220 may be an example of aspects of the transceiver 1535 described with reference to FIG. 15. The transmitter 1220 may include a single antenna, or it may include a set of antennas.

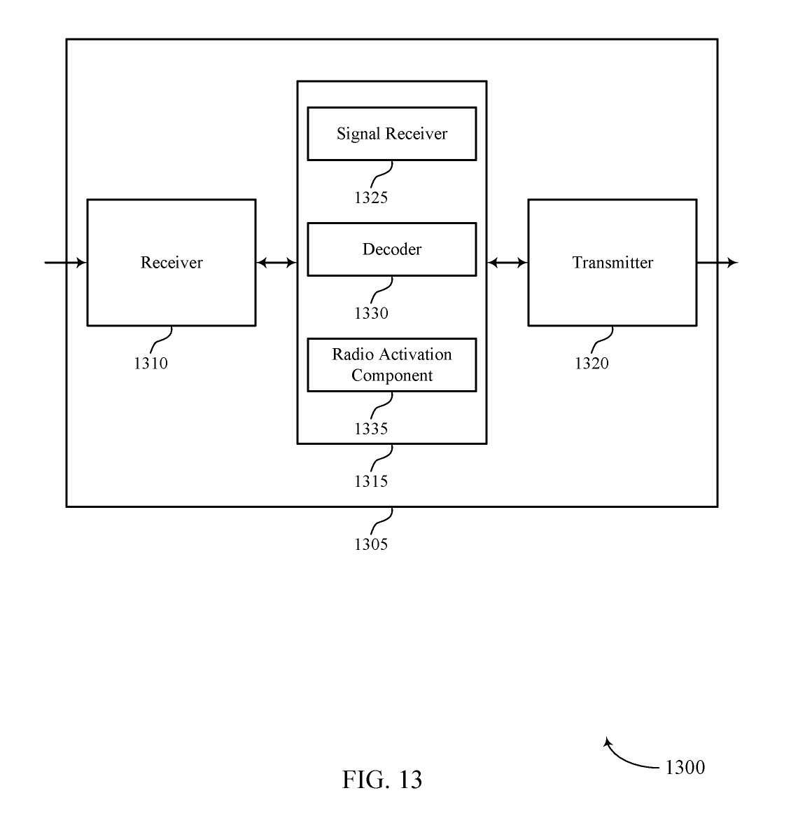

FIG. 13 shows a block diagram 1300 of a wireless device 1305 that supports MC-OOK waveform coding in accordance with various aspects of the present disclosure. Wireless device 1305 may be an example of aspects of a wireless device 1205 or a STA 115 as described with reference to FIGS. 1, 2, 4, and 12. Wireless device 1305 may include receiver 1310, STA multicarrier waveform manager 1315, and transmitter 1320. Wireless device 1305 may also include a processor. Each of these components may be in communication with one another (e.g., via one or more buses).

Receiver 1310 may receive information such as packets, user data, or control information associated with various information channels (e.g., control channels, data channels, and information related to MC-OOK waveform coding, etc.). Information may be passed on to other components of the device. The receiver 1310 may be an example of aspects of the transceiver 1535 described with reference to FIG. 15.

STA multicarrier waveform manager 1315 may be an example of aspects of the STA multicarrier waveform manager 1515 described with reference to FIG. 15. STA multicarrier waveform manager 1315 may also include signal receiver 1325, decoder 1330, and radio activation component 1335. In some examples, the STA multicarrier waveform manager 1315 may be a processor (e.g., a transceiver processor, or a radio processor, or a receiver processor). The processor may be coupled with memory and execute instructions stored in the memory that enable the processor to perform or facilitate the MC-OOK waveform coding features discussed herein. A transceiver processor may be collocated with and/or communicate with (e.g., direct the operations of) a transceiver of the device. A radio processor may be collocated with and/or communicate with (e.g., direct the operations of) a radio (e.g., an LTE radio or a Wi-Fi radio) of the device. A receiver processor may be collocated with and/or communicate with (e.g., direct the operations of) a receiver of the device.

Signal receiver 1325 may receive a multicarrier wakeup signal at a first radio of a wireless device, where the multicarrier wakeup signal is modulated using a set of OOK patterns, each of the set of OOK patterns including one or more on portions and one or more off portions, a first OOK pattern used to generate a first waveform representing a first bit value, and a second OOK pattern used to generate a second waveform representing a second bit value. In some cases, the first OOK pattern includes a first on portion followed by a first off portion. In some cases, the second OOK pattern includes a second off portion followed by a second on portion. In some cases, the multicarrier wakeup signal is received to the first radio of the wireless device using a second set of subcarriers, the second set of subcarriers being a subset of the first set of subcarriers. In some cases, the signal receiver 1325 may be a processor (e.g., a transceiver processor, or a radio processor, or a receiver processor). The processor may be coupled with memory and execute instructions stored in the memory that enable the processor to perform or facilitate the signal receiving features discussed herein.

Decoder 1330 may decode the multicarrier wakeup signal based on the set of OOK patterns. In some cases, decoding the multicarrier wakeup signal includes determining a first energy associated with a first time period of the multicarrier wakeup signal and determining a second energy associated with a second time period of the multicarrier wakeup signal. In some cases, the decoder 1330 may be a processor (e.g., a transceiver processor, or a radio processor, or a receiver processor). The processor may be coupled with memory and execute instructions stored in the memory that enable the processor to perform or facilitate the decoding features discussed herein.

Radio activation component 1335 may activate a second radio of the wireless device based on the decoding and determine whether to activate the second radio of the wireless device based on the comparing. In some cases, the radio activation component 1335 may be a processor (e.g., a transceiver processor, or a radio processor, or a receiver processor). The processor may be coupled with memory and execute instructions stored in the memory that enable the processor to perform or facilitate the radio activating features discussed herein.

Transmitter 1320 may transmit signals generated by other components of the device. In some examples, the transmitter 1320 may be collocated with a receiver 1310 in a transceiver module. For example, the transmitter 1320 may be an example of aspects of the transceiver 1535 described with reference to FIG. 15. The transmitter 1320 may include a single antenna, or it may include a set of antennas.

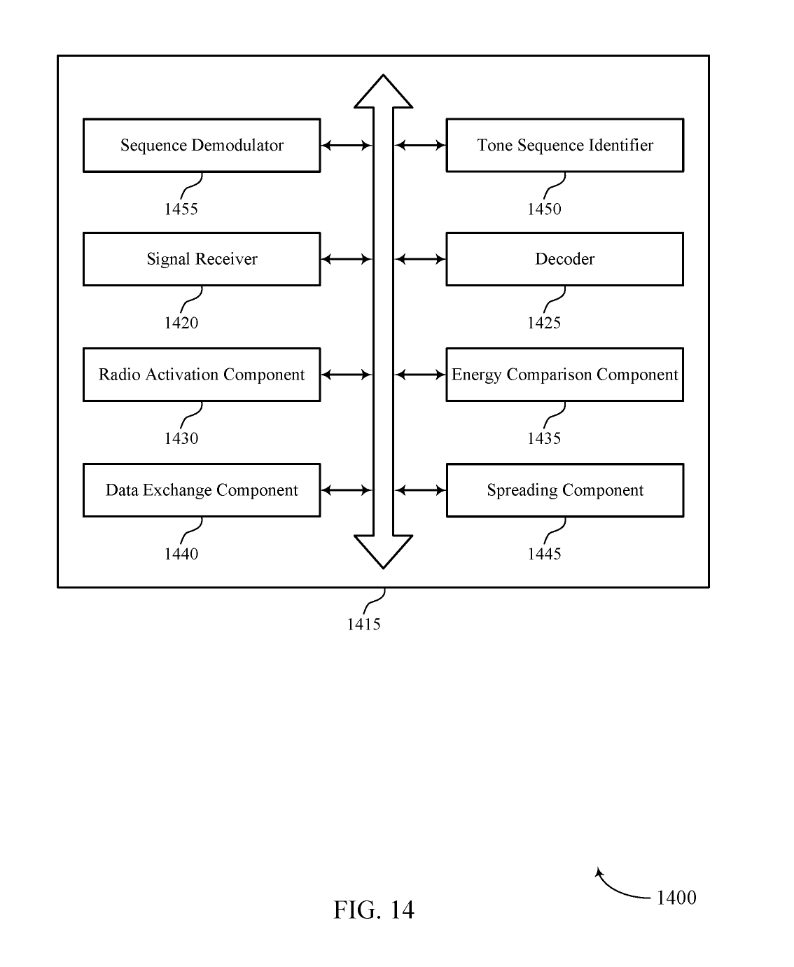

FIG. 14 shows a block diagram 1400 of a STA multicarrier waveform manager 1415 that supports MC-OOK waveform coding in accordance with various aspects of the present disclosure. STA multicarrier waveform manager 1415 may be an example of aspects of a STA multicarrier waveform manager 1215 described with reference to FIGS. 12, 13, and 15. STA multicarrier waveform manager 1415 may include signal receiver 1420, decoder 1425, radio activation component 1430, energy comparison component 1435, data exchange component 1440, and spreading component 1445. Each of these modules may communicate, directly or indirectly, with one another (e.g., via one or more buses).

Signal receiver 1420 may receive a multicarrier wakeup signal at a first radio of a wireless device, where the multicarrier wakeup signal is modulated using a set of OOK patterns, each of the set of OOK patterns including one or more on portions and one or more off portions, a first OOK pattern used to generate a first waveform representing a first bit value, and a second OOK pattern used to generate a second waveform representing a second bit value. In some cases, the first OOK pattern includes a first on portion followed by a first off portion. In some cases, the second OOK pattern includes a second off portion followed by a second on portion. In some cases, the multicarrier wakeup signal is received to the first radio of the wireless device using a second set of subcarriers, the second set of subcarriers being a subset of the first set of subcarriers. In some cases, the signal receiver 1420 may be a processor (e.g., a transceiver processor, or a radio processor, or a receiver processor). The processor may be coupled with memory and execute instructions stored in the memory that enable the processor to perform or facilitate the signal receiving features discussed herein.

Decoder 1425 may decode the multicarrier wakeup signal based on the set of OOK patterns. In some cases, decoding the multicarrier wakeup signal includes determining a first energy associated with a first time period of the multicarrier wakeup signal and determining a second energy associated with a second time period of the multicarrier wakeup signal. In some cases, decoder 1425 may be a processor (e.g., a transceiver processor, or a radio processor, or a receiver processor). The processor may be coupled with memory and execute instructions stored in the memory that enable the processor to perform or facilitate the decoding features discussed herein.

Radio activation component 1430 may activate a second radio of the wireless device based on the decoding and determine whether to activate the second radio of the wireless device based on the comparing. In some cases, the radio activation component 1430 may be a processor (e.g., a transceiver processor, or a radio processor, or a receiver processor). The processor may be coupled with memory and execute instructions stored in the memory that enable the processor to perform or facilitate the radio activating features discussed herein.

Energy comparison component 1435 may compare the determined first energy to the determined second energy. In some cases, the energy comparison component 1435 may be a processor (e.g., a transceiver processor, or a radio processor, or a receiver processor). The processor may be coupled with memory and execute instructions stored in the memory that enable the processor to perform or facilitate the energy comparing features discussed herein.

Data exchange component 1440 may exchange data with an access point using the activated second radio of the wireless device. In some cases, the data is exchanged with the access point using a first set of subcarriers. In some cases, the data exchange component 1440 may be a processor (e.g., a transceiver processor, or a radio processor, or a receiver processor). The processor may be coupled with memory and execute instructions stored in the memory that enable the processor to perform or facilitate the data exchange features discussed herein.

Spreading component 1445 may spread a set of bits to generate a set of spread bits. In some cases, each of the set of OOK patterns include a set of spread bits encoded with an on-off pattern including at least one on portion and at least one off portion, where the total duration of the at least one on portion equals the total duration of the at least one off portion. In some cases, the set of spread bits are generated by spreading a set of code bits, the set of code bits generated by an encoder implementing a FEC code that operates on each of a set of information bits. In some cases, the FEC code includes a convolutional code, a turbo code, or a LDPC code. In some cases, the set of spread bits are generated by repeating each of a set of bits one or more times. In some cases, the set of spread bits are generated by mapping a set of bits to a set of orthogonal bit sequences. In some cases, the set of orthogonal bit sequences include a first orthogonal bit sequence and a second orthogonal bit sequence, the first orthogonal bit sequence complementary to the second orthogonal bit sequence.

Tone sequence identifier 1450 may identify, in the one or more on portions of the multicarrier wakeup signal, a tone sequence on a set of subcarriers, and identify the one or more information bits associated with the one of the set of tone sequences. In some cases, decoding the one or more information bits based on the identified tone sequence includes determining that the identified tone sequence is one of a set of tone sequences used to encode information bits during on portions of multicarrier wakeup signals.

Sequence demodulator 1455 may demodulate each tone of the identified tone sequence to obtain the one or more information bits, each tone phase shift key modulated. In some cases, decoding the one or more information bits based on the identified tone sequence includes demodulate each tone of the identified tone sequence to obtain the one or more information bits, each tone phase shift key modulated.

FIG. 15 shows a diagram of a system 1500 including a device 1505 that supports MC-OOK waveform coding in accordance with various aspects of the present disclosure. Device 1505 may be an example of or include the components of STA 115 as described above, e.g., with reference to FIGS. 1, 2, 4, and 12 through 14. Device 1505 may include components for bi-directional voice and data communications including components for transmitting and receiving communications, including STA multicarrier waveform manager 1515, processor 1520, memory 1525, software 1530, transceiver 1535, antenna 1540, I/O controller 1545, and wakeup radio 1555. These components may be in electronic communication via one or more busses (e.g., bus 1510). Transceiver 1535 may include a primary radio, which may be an example of a primary radio 116 described with reference to FIG. 1. Wakeup radio 1555 may be an example of a wakeup radio 117 described with reference to FIG. 1.

Processor 1520 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, processor 1520 may be configured to operate a memory array using a memory controller. In other cases, a memory controller may be integrated into processor 1520. Processor 1520 may be configured to execute computer-readable instructions stored in a memory to perform various functions (e.g., functions or tasks supporting MC-OOK waveform coding).

Memory 1525 may include RAM and ROM. The memory 1525 may store computer-readable, computer-executable software 1530 including instructions that, when executed, cause the processor to perform various functions described herein. In some cases, the memory 1525 may contain, among other things, a BIOS which may control basic hardware and/or software operation such as the interaction with peripheral components or devices.

Software 1530 may include code to implement aspects of the present disclosure, including code to support MC-OOK waveform coding. Software 1530 may be stored in a non-transitory computer-readable medium such as system memory or other memory. In some cases, the software 1530 may not be directly executable by the processor but may cause a computer (e.g., when compiled and executed) to perform functions described herein.

Transceiver 1535 may communicate bi-directionally, via one or more antennas, wired, or wireless links as described above. For example, the transceiver 1535 may represent a wireless transceiver and may communicate bi-directionally with another wireless transceiver. The transceiver 1535 may also include a modem to modulate the packets and provide the modulated packets to the antennas for transmission, and to demodulate packets received from the antennas.

In some cases, the wireless device may include a single antenna 1540. However, in some cases the device may have more than one antenna 1540, which may be capable of concurrently transmitting or receiving multiple wireless transmissions. Antenna 1540 may include an antenna (e.g., a separate antenna than for the primary radio) used to transmit signals to and receive signals from wakeup radio 1555 (e.g., wakeup signals).

I/O controller 1545 may manage input and output signals for device 1505. I/O controller 1545 may also manage peripherals not integrated into device 1505. In some cases, I/O controller 1545 may represent a physical connection or port to an external peripheral. In some cases, I/O controller 1545 may utilize an operating system such as iOS®, ANDROID®, MS-DOS®, MS-WINDOWS®, OS/2®, UNIX®, LINUX®, or another known operating system.

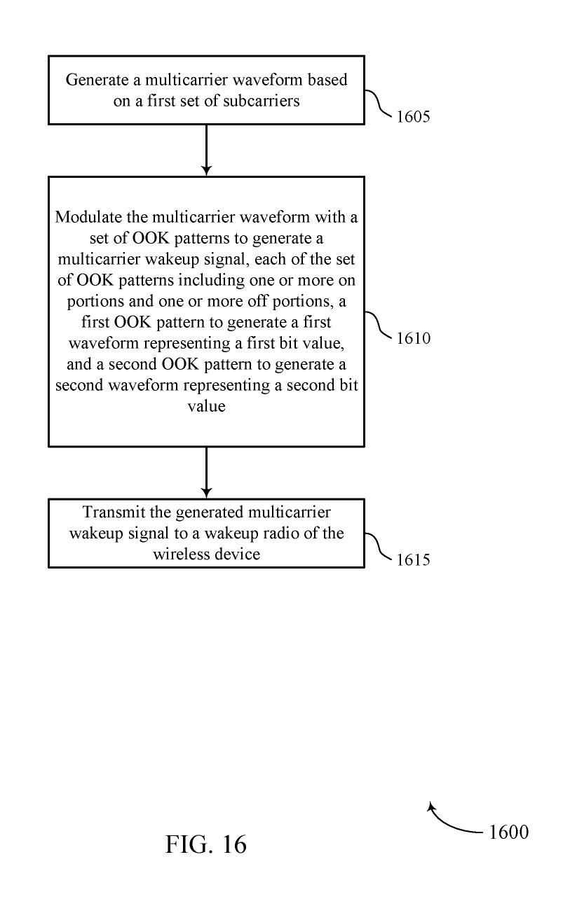

FIG. 16 shows a flowchart illustrating a method 1600 for MC-OOK waveform coding in accordance with various aspects of the present disclosure. The operations of method 1600 may be implemented by an AP 105 or its components as described herein. For example, the operations of method 1600 may be performed by an AP multicarrier waveform manager as described with reference to FIGS. 8 through 11. In some examples, an AP 105 may execute a set of codes to control the functional elements of the device to perform the functions described below. Additionally or alternatively, the AP 105 may perform aspects of the functions described below using special-purpose hardware.

At block 1605 the AP 105 may generate a multicarrier waveform based on a first plurality of subcarriers. The operations of block 1605 may be performed according to the methods described with reference to FIGS. 1 through 7. In certain examples, aspects of the operations of block 1605 may be performed by a waveform generator as described with reference to FIGS. 8 through 11.

At block 1610 the AP 105 may modulate the multicarrier waveform with a plurality of OOK patterns to generate a multicarrier wakeup signal, each of the plurality of OOK patterns including one or more on portions and one or more off portions, a first OOK pattern to generate a first waveform representing a first bit value, and a second OOK pattern to generate a second waveform representing a second bit value. In some cases, the multicarrier waveform with the plurality of OOK patterns to generate a multicarrier wakeup signal further includes spreading a plurality of bits to generate a plurality of spread bits, encoding each spread bit of the plurality of spread bits with an on-off pattern, and applying a FEC code to a plurality of information bits to generate a plurality of code bits. The operations of block 1610 may be performed according to the methods described with reference to FIGS. 1 through 4. In certain examples, aspects of the operations of block 1610 may be performed by a pattern modulation component as described with reference to FIGS. 8 through 11.

At block 1615 the AP 105 may transmit the generated multicarrier wakeup signal to a wakeup radio of the wireless device. The operations of block 1615 may be performed according to the methods described with reference to FIGS. 1 through 7. In certain examples, aspects of the operations of block 1615 may be performed by a signal transmitter as described with reference to FIGS. 8 through 11.

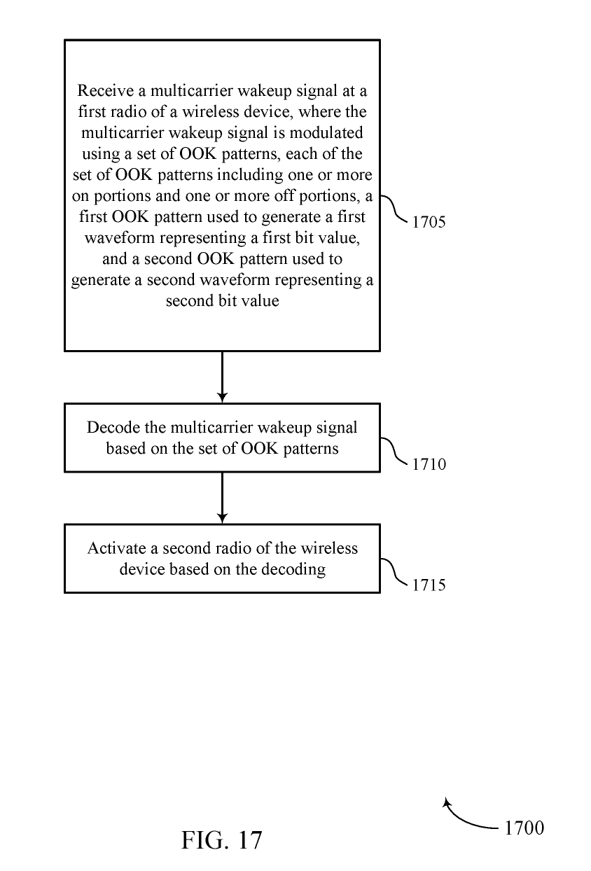

FIG. 17 shows a flowchart illustrating a method 1700 for MC-OOK waveform coding in accordance with various aspects of the present disclosure. The operations of method 1700 may be implemented by a STA 115 or its components as described herein. For example, the operations of method 1700 may be performed by a STA multicarrier waveform manager as described with reference to FIGS. 12 through 15. In some examples, a STA 115 may execute a set of codes to control the functional elements of the device to perform the functions described below. Additionally or alternatively, the STA 115 may perform aspects of the functions described below using special-purpose hardware.

At block 1705 the STA 115 may receive a multicarrier wakeup signal at a first radio of a wireless device, where the multicarrier wakeup signal is modulated using a plurality of OOK patterns, each of the plurality of OOK patterns including one or more on portions and one or more off portions, a first OOK pattern used to generate a first waveform representing a first bit value, and a second OOK pattern used to generate a second waveform representing a second bit value. The operations of block 1705 may be performed according to the methods described with reference to FIGS. 1 through 4. In certain examples, aspects of the operations of block 1705 may be performed by a signal receiver as described with reference to FIGS. 12 through 15.

At block 1710 the STA 115 may decode the multicarrier wakeup signal based on the plurality of OOK patterns. The operations of block 1710 may be performed according to the methods described with reference to FIGS. 1 through 4. In certain examples, aspects of the operations of block 1710 may be performed by a decoder as described with reference to FIGS. 12 through 15.

At block 1715 the STA 115 may activate a second radio of the wireless device based on the decoding. The operations of block 1715 may be performed according to the methods described with reference to FIGS. 1 through 4. In certain examples, aspects of the operations of block 1715 may be performed by a radio activation component as described with reference to FIGS. 12 through 15.

It should be noted that the methods described above describe possible implementations, and that the operations and the steps may be rearranged or otherwise modified and that other implementations are possible. Further, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc.

The wireless communications system or systems described herein may support synchronous or asynchronous operation. For synchronous operation, the stations may have similar frame timing, and transmissions from different stations may be approximately aligned in time. For asynchronous operation, the stations may have different frame timing, and transmissions from different stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, WLAN 100 and wireless communications system 200 of FIGS. 1 and 2, respectively—may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above may be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. An apparatus for wireless communications, in a system comprising:
a memory that stores instructions; and
a processor coupled with the memory, wherein the processor and the memory are configured to:
generate a multicarrier waveform based at least in part on a first plurality of subcarriers;
modulate the multicarrier waveform with a plurality of on-off keying (OOK) patterns to generate a multicarrier wakeup signal, each of the plurality of OOK patterns including one or more on portions and one or more off portions, a first OOK pattern to generate a first waveform representing a first bit value, and a second OOK pattern to generate a second waveform representing a second bit value; and
transmit the generated multicarrier wakeup signal to a wakeup radio of the wireless device.

2. The apparatus of claim 1, wherein the multicarrier waveform comprises a fixed sequence of tones for the first plurality of subcarriers in symbol periods of the one or more on portions.

3. The apparatus of claim 2, wherein the fixed sequence of tones comprises:
a first binary phase shift keying (BPSK) 1 tone on a first of the plurality of subcarriers;
a second BPSK 1 tone on a second of the plurality of subcarriers;
a third BPSK 1 tone on a third of the plurality of subcarriers;
a first BPSK −1 tone on a fourth of the plurality of subcarriers;
a second BPSK −1 tone on a fifth of the plurality of subcarriers;
a third BPSK −1 tone on a sixth of the plurality of subcarriers;
a direct current (DC) tone on a seventh of the plurality of subcarriers;
a fourth BPSK −1 tone on an eighth of the plurality of subcarriers;
a fourth BPSK 1 tone on a ninth of the plurality of subcarriers;
a fifth BPSK −1 tone on a tenth of the plurality of subcarriers;
a sixth BPSK −1 tone on an eleventh of the plurality of subcarriers;
a fifth BPSK 1 tone on a twelfth of the plurality of subcarriers; and
a seventh BPSK −1 tone on a thirteenth of the plurality of subcarriers.

4. The apparatus of claim 2, wherein the fixed sequence of tones comprises:
a first binary phase shift keying (BPSK) 1 tone on a first of the plurality of subcarriers;
a second BPSK 1 tone on a second of the plurality of subcarriers;
a third BPSK 1 tone on a third of the plurality of subcarriers;
a first BPSK −1 tone on a fourth of the plurality of subcarriers;
a second BPSK −1 tone on a fifth of the plurality of subcarriers;
a third BPSK −1 tone on a sixth of the plurality of subcarriers;
a fourth BPSK 1 tone on a seventh of the plurality of subcarriers;
a fifth BPSK 1 tone on an eighth of the plurality of subcarriers;
a fourth BPSK −1 tone on a ninth of the plurality of subcarriers;
a sixth BPSK 1 tone on a tenth of the plurality of subcarriers;
a seventh BPSK 1 tone on an eleventh of the plurality of subcarriers;
a fifth BPSK −1 tone on a twelfth of the plurality of subcarriers; and
an eighth BPSK 1 tone on a thirteenth of the plurality of subcarriers.

5. The apparatus of claim 2, wherein the fixed sequence of tones for the first plurality of subcarriers comprises thirteen tones located at tone indices −6:6 of a channel.

6. The apparatus of claim 1, wherein the processor and memory are configured to generate the multicarrier waveform based at least in part on the first plurality of subcarriers by being configured to:
encode information bits in the plurality of subcarriers during the one or more on portions.

7. The apparatus of claim 1, wherein the processor and memory are configured to modulate the multicarrier waveform with the plurality of OOK patterns to generate a multicarrier wakeup signal by being configured to:
spread a plurality of bits to generate a plurality of spread bits; and
encode each spread bit of the plurality of spread bits with an on-off pattern comprising at least one on portion and at least one off portion, wherein the total duration of the at least one on portion equals the total duration of the at least one off portion.

8. The apparatus of claim 7, wherein the processor and memory are configured to modulate the multicarrier waveform with the plurality of OOK patterns to generate a multicarrier wakeup signal by being configured to:
apply a forward error correction (FEC) code to a plurality of information bits to generate a plurality of code bits, wherein plurality of code bits comprise the plurality of bits to be spread.

9. The apparatus of claim 8, wherein the FEC code comprises a convolutional code, or a turbo code, or a low-density parity-check (LDPC) code, or a combination thereof.

10. The apparatus of claim 7, wherein the processor and memory are configured to spread the plurality of bits by being configured to:
repeat each bit of the plurality of bits one or more times to generate the plurality of spread bits.

11. The apparatus of claim 7, wherein the processor and memory are configured to spread the plurality of bits by being configured to:
map the plurality of bits to a plurality of orthogonal bit sequences.

12. The apparatus of claim 11, wherein:
the plurality of orthogonal bit sequences comprise a first orthogonal bit sequence and a second orthogonal bit sequence, the first orthogonal bit sequence complementary to the second orthogonal bit sequence; and
the processor and memory are configured to map the plurality of bits to the plurality of orthogonal bit sequences by being configured to map each of the plurality of bits to the first orthogonal bit sequence or the second orthogonal bit sequence.

13. The apparatus of claim 7, wherein a number of the at least one on portion and a number of the at least one off portion are equal.

14. The apparatus of claim 1, wherein:
the multicarrier wakeup signal spans an integer multiple of an orthogonal frequency division multiplexing (OFDM) symbol period.

15. The apparatus of claim 1, wherein:
the first OOK pattern comprises a first on portion followed by a first off portion; and
the second OOK pattern comprises a second off portion followed by a second on portion.

16. The apparatus of claim 1, wherein the processor and memory are configured to:
identify a pending communication for a wireless device; and
exchange data with a second radio of the wireless device based at least in part on the transmitted multicarrier wakeup signal and the pending communication.

17. The apparatus of claim 16, wherein:
the data is exchanged with the second radio of the wireless device using a second plurality of subcarriers; and
the generated multicarrier wakeup signal is transmitted to the wakeup radio of the wireless device using first plurality of subcarriers, the first plurality of subcarriers being a subset of the second plurality of subcarriers.

18. An apparatus for wireless communications, in a system comprising:
a memory that stores instructions; and
a processor coupled with the memory, wherein the processor and the memory are configured to:
receive a multicarrier wakeup signal at a first radio of a wireless device, wherein the multicarrier wakeup signal is modulated using a plurality of on-off keying (OOK) patterns, each of the plurality of OOK patterns including one or more on portions and one or more off portions, a first OOK pattern used to generate a first waveform representing a first bit value, and a second OOK pattern used to generate a second waveform representing a second bit value;
decode the multicarrier wakeup signal based at least in part on the plurality of OOK patterns; and
activate a second radio of the wireless device based at least in part on the decoding.

19. The apparatus of claim 18, wherein the processor and memory are configured to:
identify, in the one or more on portions of the multicarrier wakeup signal, a tone sequence on a plurality of subcarriers; and
decode one or more information bits based at least in part on the identified sequence of tones.

20. The apparatus of claim 18, wherein the processor and memory are configured to decode the one or more information bits based at least in part on the identified tone sequence by being configured to:
determine that the identified tone sequence is one of a set of tone sequences used to encode information bits during on portions of multicarrier wakeup signals; and
identify the one or more information bits associated with the one of the set of tone sequences.

21. The apparatus of claim 18, wherein the processor and memory are configured to decode the one or more information bits based at least in part on the identified tone sequence by being configured to:
demodulate each tone of the identified tone sequence to obtain the one or more information bits, each tone phase shift key modulated.

22. The apparatus of claim 18, wherein each of the plurality of OOK patterns comprise a plurality of spread bits encoded with an on-off pattern comprising at least one on portion and at least one off portion, wherein the total duration of the at least one on portion equals the total duration of the at least one off portion.

23. The apparatus of claim 22, wherein the plurality of spread bits are generated by spreading a plurality of code bits, the plurality of code bits generated by an encoder implementing a forward error correction (FEC) code that operates on each of a plurality of information bits.

24. The apparatus of claim 22, wherein the plurality of spread bits are generated by repeating each of a plurality of bits one or more times.

25. The apparatus of claim 22, wherein the plurality of spread bits are generated by mapping a plurality of bits to a plurality of orthogonal bit sequences.

26. The apparatus of claim 18, wherein the processor and memory are configured to decode the multicarrier wakeup signal by being configured to:
determine a first energy associated with a first time period of the multicarrier wakeup signal; and
determine a second energy associated with a second time period of the multicarrier wakeup signal.

27. The apparatus of claim 26, wherein the processor and memory are configured to:
compare the determined first energy to the determined second energy; and
determine whether to activate the second radio of the wireless device based at least in part on the comparing.

28. The apparatus of claim 18, wherein:
the first OOK pattern comprises a first on portion followed by a first off portion; and
the second OOK pattern comprises a second off portion followed by a second on portion.

29. A method for wireless communications, comprising:
generating a multicarrier waveform based at least in part on a first plurality of subcarriers;
modulating the multicarrier waveform with a plurality of on-off keying (OOK) patterns to generate a multicarrier wakeup signal, each of the plurality of OOK patterns including one or more on portions and one or more off portions, a first OOK pattern to generate a first waveform representing a first bit value, and a second OOK pattern to generate a second waveform representing a second bit value; and
transmitting the generated multicarrier wakeup signal to a wakeup radio of the wireless device.

30. A method for wireless communications, comprising:
receiving a multicarrier wakeup signal at a first radio of a wireless device, wherein the multicarrier wakeup signal is modulated using a plurality of on-off keying (OOK) patterns, each of the plurality of OOK patterns including one or more on portions and one or more off portions, a first OOK pattern used to generate a first waveform representing a first bit value, and a second OOK pattern used to generate a second waveform representing a second bit value;
decoding the multicarrier wakeup signal based at least in part on the plurality of OOK patterns; and
activating a second radio of the wireless device based at least in part on the decoding.
